(19) United States
(12) Patent Application Publication
(10) Pub. No.: US 2010/0085919 A1
(43) Pub. Date: Apr. 8, 2010

(54) AMBLE MODULATION SERIES

(75) Inventor: Changqin HUO, Calgary (CA)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/634,197

(22) Filed: Dec. 9, 2009

Related U.S. Application Data
(62) Division of application No. 11/744,290, filed on May 4, 2007.

(51) Int. Cl. H04W 4/00

(52) U.S. Cl. 370/328

(57) ABSTRACT

A base station in a multi-hop network wirelessly transmits a preamble series to be received by a subscriber station in the network, and wirelessly transmits a reverse version of the preamble series to be received by a relay station in the network. The relay station receives the transmitted reverse version of the preamble series. The subscriber station receives the transmitted the preamble series.

### CROSS-REFERENCE TO RELATED APPLICATIONS

This application is a divisional of U.S. application Ser. No. 11/744,290, filed May 4, 2007, which is incorporated herein by reference in its entirety.

This application is based on, and claims the benefit of, U.S. Provisional Application No. 60/892,704, filed Mar. 2, 2007, inventor Changqin HUO, and which is incorporated herein by reference in its entirety.

### BACKGROUND OF THE INVENTION

There are many different types of wireless networks in which a base station (BS) communicates with a subscriber station (SS). A subscriber station (SS) might be, for example, a mobile station (MS).

An Institute of Electrical and Electronics Engineers (IEEE) 802.16 network is one type of wireless network in which a base station (BS) communicates with a subscriber station (SS). IEEE 802.16j is a new addition to the IEEE 802.16 suite of standards, and is currently being defined. IEEE 802.16j governs the behavior of a relay station (RS) operating within an IEEE 802.16e mobile network. An IEEE 802.16e mobile network is often referred to as a “WiMAX” mobile network. An IEEE 802.16j network is often referred to as a Mobile Relay System (MRS).

In an IEEE 802.16j network, a base station that can support at least one relay station is referred to as a mobile relay base station (MR-BS). The purpose of using relay stations in the network is to extend radio coverage or to increase the throughput of a mobile relay base station (MR-BS). A relay station (RS) would typically be a low-cost alternative to a mobile relay base station (MR-BS).

A relay station (RS) transfers data of active service flows between a mobile relay base station (MR-BS) and subscriber stations (SS), in both an uplink direction and a downlink direction. The uplink direction refers to transmissions from the subscriber station (SS) to the relay station (RS), and from the relay station (RS) to the mobile relay base station (MR-BS). The downlink direction refers to transmissions from the mobile relay base station (MR-BS) to a relay station (RS), and from a relay station (RS) to a subscriber station (SS).

Relay stations (RS) may be linked together into a chain, forming a so-called multi-hop relay station connection, or a multi-hop relay station branch, in which one relay station (RS) passes data to and from another relay station (RS).

In a MRS, a downlink transmission is composed of an access zone and one or more relay zones. The access zone is used by a subscriber station (SS) to access the network. In the access zone, a mobile relay base station (MR-BS) or relay station (RS) transmits data to a subscriber station (SS) directly. The relay zones are used by a mobile relay base station (MR-BS) or relay station (RS) to transmit to a subscriber stations (SS) through child relay stations (RSs).

For example, FIG. 1 is a diagram illustrating a network which includes a mobile relay base station (MR-BS) 20, a relay station (RS) 22 and a subscriber station (SS) 24. Subscriber station (SS) 24 might be, for example, a mobile station.

Referring now to FIG. 1, mobile relay base station (MR-BS) 20 communicates with relay station (RS) 22 in relay zone 26. Relay station (RS) 22 communicates directly with subscriber station (SS) 24 in access zone 28.

FIG. 2 is a diagram illustrating a network which includes a multi-hop relay station connection. Referring now to FIG. 2, mobile relay base station (MR-BS) 30 communicates with relay station (RS) 32 in relay zone 31. Relay station (RS) 32 communicates with relay station (RS) 34 in relay zone 33. Relay station (RS) 34 communicates directly with subscriber station (SS) 36 in access zone 35.

With the introduction of relay stations into the network, there is a need to reconsider various aspects of network design and implementation.

### SUMMARY OF THE INVENTION

Various embodiments of the present invention are directed to an amble modulation series in a downlink relay zone in an IEEE 802.16 network, the amble modulation series being a reverse version of a preamble modulation series of the network.

For example, various embodiments of the present invention are directed to an amble modulation series PNᵢ^{A} for a downlink relay zone in an IEEE 802.16 network, the amble modulation series being related to a preamble modulation series PNᵢ, i=0, 1, . . . , 113 of the IEEE 802.16 network as follows:

PNᵢ^{A}(j)=PNᵢ(J−j), i=0, 1, . . . , 113, j=0, 1, . . . , J

where J is dependent on a Fast Fourier Transform (FFT) size of the network, and is equal to 567, 283 and 142 for an FFT size of 2048, 1024 and 512, respectively.

In various embodiments of the present invention, the amble modulation series is easily understood when shown in table form.

The above-described embodiments of the present invention are intended as examples, and all embodiments of the present invention are not limited to including features described in the above examples.

### BRIEF DESCRIPTION OF THE DRAWINGS

FIG. 1 is a diagram illustrating a network which includes a mobile relay base station, a relay station and a subscriber station.

FIG. 2 is a diagram illustrating a network which includes a multi-hop relay station connection.

FIG. 3 is a diagram illustrating the use of an amble modulation series, according to an embodiment of the present invention.

FIGS. 4 and 5 are diagrams illustrating the performance of an associated amble modulation series, according to an embodiment of the present invention.

FIG. 6 is a diagram illustrating a network using an amble modulation series, according to an embodiment of the present invention.

FIG. 7 is a diagram illustrating a network using an amble modulation series, according to an additional embodiment of the present invention.

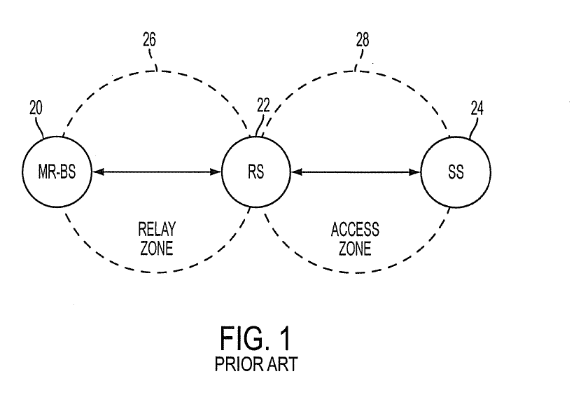

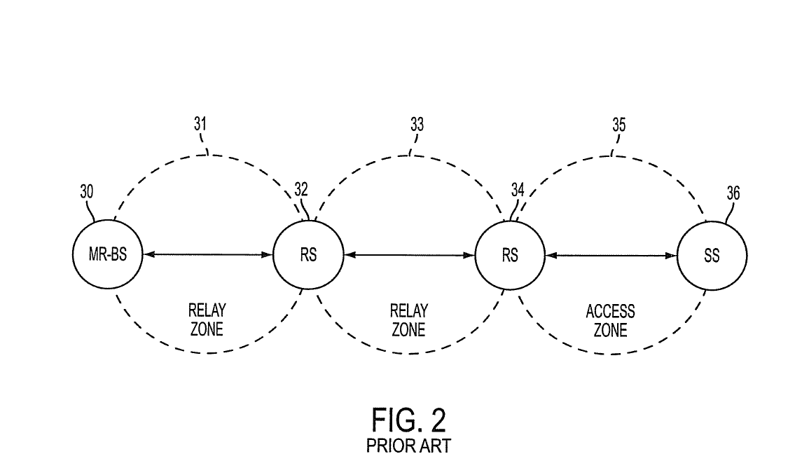

### DESCRIPTION OF THE PREFERRED EMBODIMENTS

Reference will now be made in detail to embodiments of the present invention, examples of which are illustrated in the accompanying drawings, wherein like reference numerals refer to like elements throughout.

Much of the terminology used herein, including abbreviations, is defined in IEEE 802.16-2004, IEEE 802.16e-2005, IEEE 802.16-2005, and IEEE 802.16j-06/026r2, which are incorporated herein by reference in their entireties.

In IEEE 802.16e networks, the first symbol of a downlink transmission is referred to as the preamble. The preamble is used by a subscriber station (SS) to perform measurements and procedures such as time synchronization, carrier frequency estimation, channel response estimation, cell and sector identification, etc. Performing such measurements and procedures in accordance with the preamble is well-known.

According to embodiments of the present invention, a similar amble can be introduced into relay zones to achieve the similar objectives as the preambles.

A set of 114 preamble modulation series are specified in IEEE 802.16e, which is incorporated by reference herein in its entirety. This defined set of preamble modulation series was originally intended to be used in an access zone. More specifically, this defined set of preamble modulation series was originally intended to be used between a base station (BS) and a subscriber station (SS) in networks that do not use relay stations. In such networks, without the use of relay stations, the subscriber station (SS) must be in communication range of the base station (BS).

One option for a relay zone amble modulation series is to use the same preamble modulation series defined in 802.16e, i.e., the one used in the access zone in mobile relay networks. However, as the same preamble modulation series would be used in both the access zone and the relay zone, this option could cause problems since subscriber stations (SS) could detect the same preamble twice in one frame.

According to embodiments of the present invention, a new set of amble modulation series PNᵢ^{A}, i=0, 1, . . . , 113, is to be used in the downlink (DL) relay zone of an IEEE 802.16 network. The new amble modulation series is related to the original preamble modulation series PNᵢ^{A}, i=0, 1, . . . , 113 specified in 8.4.6.1.1 in IEEE 802.16-2005, which is incorporated herein by reference in its entirety, as indicated by the following equation:

PNᵢ^{A}(j)=PNᵢ(J−j), i=0, 1, . . . , 113, j=0, 1, . . . , J (1)

where J is dependent on the Fast Fourier Transform (FFT) size used in the system.

The FFT size of the network would be readily known. More specifically, an IEEE 802.16 network has an associated FFT size on which the network is designed. IEEE 802.16 currently specifies the use of networks with an FFT size of, for example, 2048, 1024 or 512. However, the present invention is not limited the networks having an FFT size of 2048, 1024 or 512. Instead, a network could have a different FFT size. The above equation would still apply to networks having different FFT sizes. However, the value of J would be different for different FFT sizes.

J=(number of characters defined in the system)×(number of bits per character)−n,

where n=1 for FFT size of 2048 and 1024, and n=2 for FFT size of 512.

For example, in an 802.16e network with an FFT size of 1024, there are 71 characters, with four bits per character. In this example, J=(71)×(4)−1=283.

Moreover, J is equal to 567, 283 and 142 for an 802.16 network with FFT size of 2048, 1024 and 512, respectively.

The new amble set PNᵢ^{A} is the reverse version of the original preamble set can be referred to as an “associated amble modulation series”.

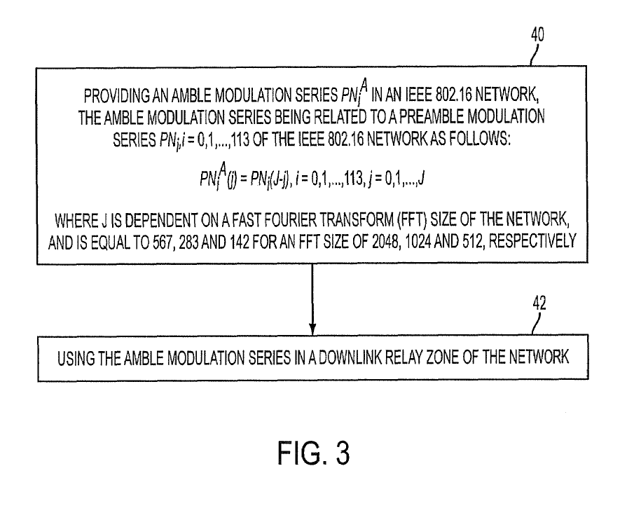

Therefore. FIG. 3 is a diagram illustrating the use of an amble modulation series according to an embodiment of the present invention. Referring now to FIG. 3, in operation 40, an amble modulation series PNᵢ^{A} is provided in an IEEE 802.16 network, the amble modulation series being related to a preamble modulation series PNᵢ, i=0, 1, . . . , 113 of the IEEE 802.16 network according to the following equation:

PNᵢ^{A}(j)=PNᵢ(J−j), i=0, 1, . . . , 113, j=0, 1, . . . , J

where J is dependent on the FFT size of the network, and is equal, for example, to 567, 283 and 142 for an FFT size of 2048, 1024 and 512, respectively.

In operation 42, the amble modulation series is used in a downlink relay zone of the network. For example, a mobile relay base station (MR-BS) can insert the amble modulation series into a frame which is transmitted by the mobile relay base station (MR-BS) in a downlink relay zone. Similarly, a relay station (RS) can insert the amble modulation series into a frame which is transmitted by the relay station (RS) in a downlink relay zone. The amble modulation series can then be used by a subordinate relay station (RS) to perform measurements and procedures such as, for example, time synchronization, carrier frequency estimation, channel response estimation, cell and sector identification, etc.

Of course, the present invention is not limited to any specific measurements or procedures being performed. Performing such measurements and procedures in accordance with the amble modulation series is similar to performing such measurements with the preamble, and would be well-understood by a person of ordinary skill in the art in view of the disclosure herein.

Based on the above equation, for the original preamble modulation series PNᵢ, i=0, 1, . . . , 113 specified in 8.4.6.1.1 in IEEE 802.16-2005, the amble modulation series PNᵢ^{A} would be as indicated in Tables 1, 2 and 3 disclosed herein for an FFT size of 2048, 1024 and 512, respectively. These tables could easily be generated from the above equation.

Moreover, for a different preamble modulation series, the equation would generate a different amble modulation series for each FFT size. Accordingly, the present invention is not limited to the specific amble modulation series shown in Tables 1, 2 and/or 3.

To use the amble modulation series, a mobile relay base station (MR-BS) or a relay station (RS) could be provided with the specific amble modulation series. For example, the mobile relay base station (MR-BS) or a relay station (RS) could be provided with a table, such as Tables 1, 2 or 3, or with information corresponding to that in Tables 1, 2 or 3. Or, the mobile relay base station (MR-BS) or a relay station (RS) might be provided with only specific ones of the amble modulation series that are required by the respective mobile relay base station (MR-BS) or the respective relay station (RS). Such tables or specific values might reside on the mobile relay base station (MR-BS) or the respective relay station (RS), or might reside elsewhere in the network and be provided to, or obtained by, the respective mobile relay base station (MR-BS) or respective relay station (RS) when needed. In an additional embodiment, a mobile relay base station (MR-BS) or relay station (RS) might generate the amble modulation series from the above equation, or be provided with the amble modulation from a different device on the network which generates the amble modulation series from the above equation, and provides the generated amble modulation series to a mobile relay base station (MR-BS) or relay station (RS) when needed.

Accordingly, embodiments of the present invention are not limited to any particular manner of generating or providing the amble modulation series to a mobile relay base station (MR-BS) or relay station (RS).

This new amble modulation series has several important properties. For example, there is one and only one associated amble for each preamble defined in IEEE 802.16-2005; hence no extra efforts are required for the new amble planning in the network deployment.

Moreover, the associated amble modulation series has the same auto-correlation and cross-correlation performance as the original preamble modulation series. This property make the associated amble set work as well as the original preamble set does.

In addition, the associated amble set has peak-to-average-power-ratio (PAPR) performance better than (or the same as) the corresponding preamble set.

Further, the cross-correlation between the associated amble modulation series and the original preamble modulation series is low enough for the purpose of the amble in relay zones.

Moreover, the associated amble series has a simple relationship with the corresponding preamble series and is easy to be implemented.

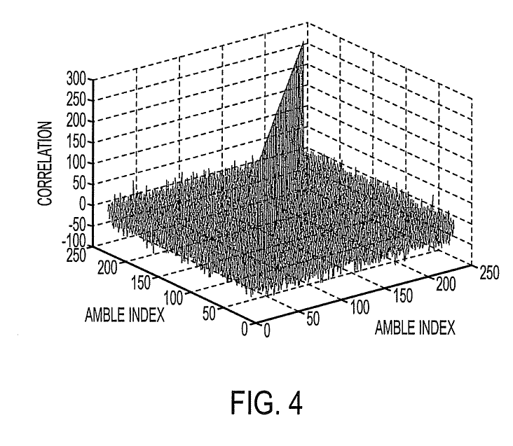

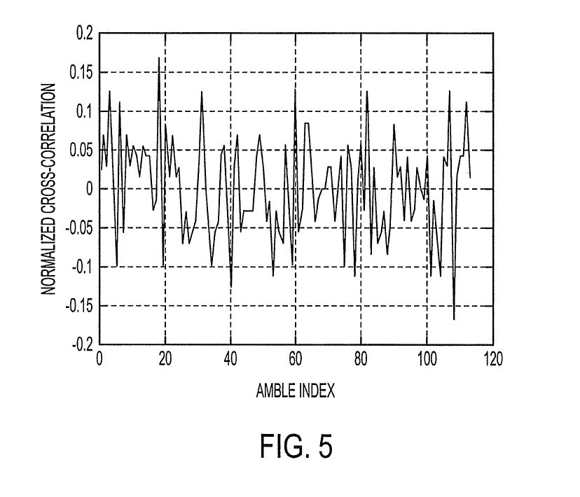

The performance of the associated amble modulation series is illustrated in FIGS. 4 and 5.

More specifically, the auto-correlation and the cross-correlation of the aggregate amble set, i.e. the preamble set (numbered from 0 to 113) and the associated amble set (numbered from 114 to 283), is illustrated in FIG. 4 for FFT size of 1024.

The normalized (by the auto-correlation, i.e. 284 for a FFT size of 1024) cross-correlation between the associated amble series and the corresponding original preamble series is illustrated in FIG. 5 for amble indexes from 0 to 113. The performance of the new amble set appears to be good enough for the purpose of the amble in the downlink (DL) relay zone.

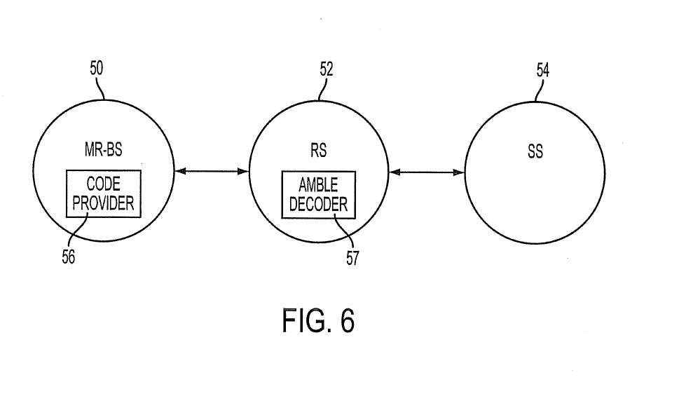

FIG. 6 is a diagram illustrating a network using an amble modulation series, according to an embodiment of the present invention. Referring now to FIG. 6, the network includes a mobile relay base station (MR-BS) 50, a relay station (RS) 52 and a subscriber station (SS) 54. Subscriber station (SS) 54 might be, for example, a mobile station. The network in FIG. 6 is an example of a two-hop architecture, since there is only one relay station (RS) 52 between mobile relay base station (MR-BS) 50 and subscriber station (SS) 54. Of course, the present invention in not limited to a two-hop architecture, or to the specific architecture shown in FIG. 6.

Mobile relay base station (MR-BS) 50 includes a code provider 56 providing the amble modulation series. Code provider 56 might include memory storing the required amble modulation series. Alternatively, code provider 56 might be a processor which generates the amble modulation series based on the above-described equation. FIG. 6 shows code provider 56 as being included on mobile relay base station (MR-BS) 50. However, the present invention is not limited to code provider 56 being at any particular location. For example, code provider 56 could be provided on a different entity in the network, with the required amble modulation series being provided to mobile relay base station (MR-BS) 50 as needed.

Mobile relay base station (MR-BS) 50 inserts the amble modulation series into a downlink frame, and transmits the frame to relay station (RS) 52. Relay station (RS) 52 includes an amble decoder 57 which decodes the amble modulation series inserted into the downlink frame. Relay station (RS) 52 then performs measurements and tests in accordance with the decoded amble modulation series.

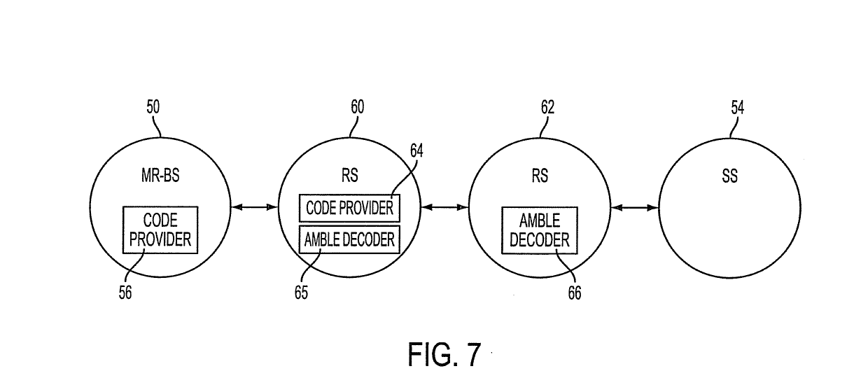

FIG. 7 is a diagram illustrating a network using an amble modulation series, according to an additional embodiment of the present invention. Referring now to FIG. 7, the network includes mobile relay base station (MR-BS) 50, relay stations (RS) 60 and 62, and subscriber station (SS) 54. The network in FIG. 7 is an example of a multi-hop architecture, since there are two relay stations (RS) 60 and 62 between mobile relay base station (MR-BS) 50 and subscriber station (SS) 54. In other embodiments, there could be additional relay stations, providing additional hops, between mobile relay base station (MR-BS) 50 and subscriber station (SS) 54. Of course, the present invention in not limited to a multi-hop architecture, or to the specific architecture shown in FIG. 7.

In the embodiment of FIG. 7, mobile relay base station (MR-BS) 50 includes code provider 56 providing the amble modulation series. In addition, relay station 60 also includes a code provider 64 and amble decoder 65. Relay station 62 includes an amble decoder 66.

FIG. 7 shows code providers 64 and 66 being included on relay stations (RS) 60 and 66, respectively. However, the present invention is not limited to code providers 64 and 66 being at any particular location. For example, code providers 64 and 66 could be provided on a different entity in the network, with the required amble modulation series being provided to relay stations as needed.

Mobile relay base station (MR-BS) 50 inserts the amble modulation series into a downlink frame, and transmits the frame to relay station (RS) 60. Amble decoder 65 of relay station (RS) 60 decodes the amble modulation series inserted into the downlink frame. Relay station (RS) 60 then performs measurements and tests in accordance with the decoded amble modulation series.

Relay station (RS) 60 also inserts an amble modulation series into its downlink frame, and transmits the new frame to relay station 62. Amble decoder 66 of relay station 62 decodes the amble series and performs measurements and tests in accordance with the decoded amble modulation series.

FIGS. 6 and 7 show a respective code provider for each mobile relay base station (MR-BS) that requires the amble modulation series. However, in some embodiments, there might be a single code provider that provides the amble modulation series to more than one mobile relay base station (MR-BS). Therefore, the present invention is not limited to any particular number or location of code providers.

The network in FIG. 7 shows only two relay stations between mobile relay base station (MR-BS) 50 and subscriber station (SS) 54. However, in various embodiments of the present invention, there might be additional relay stations (indicating additional hops) between mobile relay base station (MR-BS) 50 and subscriber station (SS) 54. In such embodiments, depending on the configuration, the additional relay stations may need the amble modulation series to transmit a frame in a downlink relay zone.

Various embodiments of the present invention are applicable to IEEE 802.16 networks, which includes amendments and extensions to IEEE 802.16. Such amendments and extensions include, but are not limited to, IEEE 802.16e and 802.16j. Moreover, the present invention is not limited to IEEE 802.16 networks, and can be applied to other types of networks.

Various embodiments of the present invention relate to networks having subscriber stations. A subscriber station might be, for example, a fixed station or mobile station. However, there are many different types of subscriber stations, and the present invention is not limited to any particular type of subscriber station.

Various network configurations are shown herein with specific numbers of mobile relay base stations (MR-BS) and relay stations (RS). However, the present invention is not limited to configurations having any specific number or configurations of mobile relay base stations (MR-BS), or any specific number or configurations of relay stations (RS).

Networks are described herein has having a FFT size. However, the present invention is not limited to networks having any specific FFT size, and embodiments of the present invention are applicable to networks having an FFT size different than in the examples described herein.

TABLE 1
Associated amble modulation series per segment and IDcell for 2048 FFT mode

| Index | IDcell | Segment | Series to modulate (in hexadecimal format) |
|---|---|---|---|
| 0 | 0 | 0 | 0xC121A1BB7304101BA89DF9CAE9B4226A120DEF3668F27BD063F0 |
| | | | 3CAA21E1B91CD2CDD7303E348A8DDE8735E99AE0A23E96F06CC57 |
| | | | C682DC5ED0650AD72FD56D28DFF36CEFED483 |
| 1 | 1 | 0 | 0xBECAD0ADAEF6007C7D70EB0F608C6AF15B70FEE272406D9161E |
| | | | 02346EA951C9504C76E63559882B41CBA45B34040ECDB1F62C44564 |
| | | | FD24B4DC3389943B7CB296BD250BD835EF95 |
| 2 | 2 | 0 | 0x5E6489881725DDDF3CE7B5EBDFDE63121D0167C75B78E19DA7C |
| | | | A210550BF14B6F5494698A467B6AEEA0FB1C8BA40DEF292A7C2898 |
| | | | F9DA2D9E11F0F5DCE446CF27CC0E1DDF8CA6A |
| 3 | 3 | 0 | 0x3C9E672D1420C9309CEF14EA6FD4F5B97A910899F3FA795C309E0 |
| | | | 142FBFE9B4E47F51E0C7A1AB8F0660626AD49AF9005C40BFC5661C |
| | | | B6F6BB2E69AB0FBB9833E8E4D7B4AAFE9CD |
| 4 | 4 | 0 | 0x1636078F624760F6197F171562F3DCD54920F31205FB3A38248DA15 |
| | | | 26F7AADD051D1066029A849FA7E94F3D62444B15962A5F328471B68 |
| | | | DC5C4471DE36FCA3BED6FB42D2132BD8 |
| 5 | 5 | 0 | 0x0664ABD924414FE4D2F5D0C6D1D37AE34FDBCE235402A7354F59 |
| | | | 6BEBA26915FE5423CCEE603C62270F6390E822E149AC1292A417C9C |
| | | | 16CD11238A96F2DF791C90D44E6DE290072 |
| 6 | 6 | 0 | 0xD39DAF85B91E70D57739D7C4789C8C8B24CA95C9B914132E03894 |
| | | | 918FCF6017ED37FB77DC6BB8033EF9B06E8CAC269BFD0E6EFB747 |
| | | | AB0FA257921E99A1976BADB087AC96D53292 |
| 7 | 7 | 0 | 0xCEC94E54FDB6580F2BD068D3DA9E3EF57BB4FB9DD1CCE9FA053 |
| | | | F40937447024908E7D1CC0D37CADD0460885DD73B7D9B04454BC16 |
| | | | D83C4A294E6A1FD61762CA10A36B26408FA32 |
| 8 | 8 | 0 | 0x744BC357950BE1E7A2FB3DC88E80CE7E62C2826B9E354C6BBFF9 |
| | | | 671D92ED6559EE78A5D77437073E9ECA51BB08072E3374F57AC17A9 |
| | | | 07A140B4D923B30625AB043064D59BE9E9E |
| 9 | 9 | 0 | 0x6C49998324893DC29F06017E1BB1FAB8B1005B509B7F6D2982F56 |
| | | | D19D4A8EA786B928458A1EFABB62BF2EE7BA04FF08E5359961BE7 |
| | | | D6E0E683C152793E60A755D9DABC34359D85 |
| 10 | 10 | 0 | 0x6C1B4CCFA8AACDE6EC6EB673A72C56C1C5DD345AE8C8D29FD |
| | | | C5253C957B7F596F0A9C66221F05218F67BAFFDD1E261EC879FF69C |
| | | | 6C9B9D4289631F9006C064DC6B00B895FA7660 |
| 11 | 11 | 0 | 0x3CD47864D59C9524DDE0CFFABD77EDC79A82A33C50C277A8399 |
| | | | 9FF6410DD607EC310CE85E52665E2B2F82A2930F435DA6CCCB5E9E |
| | | | 837298B20A5BE3EA5EC8A545BC6EFDF97C22F |
| 12 | 12 | 0 | 0x47B6EEEAC33BB91469EDDBD6AB5BCE357E70AB23C070E3973B5 |
| | | | 954072CE82F02B5E2947C20679DEF368A432360362D42C95B54D07CE |
| | | | 939749FD13E7A31106A03C121084B67D1CF |
| 13 | 13 | 0 | 0xCFB3D90E7C191FD3B4DF2A83BABC4903C1310095CE3ED22E991F |
| | | | E44980AEFE107D08C19A29EA806BB21E54B4B6B059E53790D3D2FC |
| | | | 6BBC38D418A99A252A6425C68D0E72155208 |
| 14 | 14 | 0 | 0x37C5DC6072417F46018998E9D07BB9D50BCD435BFBA9DD6CD91 |
| | | | A7B661E9EB480040346E36C0143C1C61697B9563552403833C4E813F8 |
| | | | A9B1451A600D23F8AAE3557235E0A592D0 |
| 15 | 15 | 0 | 0xB25DD8189EA22D3B7417AB0A3947442FF3DEA63BB34B8C52244E |
| | | | 40F06940A4987E7AF367C69082175901347C9344FEC3708CF50D31A77 |
| | | | FEE3BDC38DF4D67C492E5A4ECBE328326 |
| 16 | 16 | 0 | 0x0B605B518205EC8B28B6ABDFF9F70F81A3BE0277AD43D6E0D544 |
| | | | 4CF374F9722CEC9889C26F91EFAC94CE69DABB4F1389B8BD91F4BC |
| | | | A5BD0CE2F087C6E7D819FCABD4067151B084 |
| 17 | 17 | 0 | 0xB405BA2CDF90D4106E01B553E0ADE6D6404D8F1972E04DEBD95 |
| | | | A354F1A329C9EEDD6BC28197EC6C972FE297875ACEE7B9D3F8B279 |
| | | | 70B6CE50439E692DBA4ABA939EFC711506911 |
| 18 | 18 | 0 | 0xF93910D8600937D1CE7140592B1B48EB9078ABE69D7C7E25936A2 |
| | | | F5C3F94EDF8C642A00A02B409FA796A00B5B55989306B67CC8AD51 |
| | | | 0F5EE4F0B31C69B01837A53F57B313AB4B8 |
| 19 | 19 | 0 | 0xD142B09554524A773A134AAC48D2302E874A66E916587749831EBE |
| | | | 81C0433ED84FF3AD37461B838A2A439E742CA559D8B18BAFD8A213 |
| | | | CCCEF3D4A00E9F6A3FCFEC8367BC07C605 |
| 20 | 20 | 0 | 0x7FBAB81D84E3994F2A0DF770691EA0C38E41A381C82D23DE2F1B |
| | | | A1905771FBBB267D419A898F3A13380DC3D366C88028850CC250D35 |
| | | | 456D6D8E24566746495C9099A95648FE54B |
| 21 | 21 | 0 | 0x4A526A123B7CAA3C8BE39404879EB98A7ADF92F70692D066880C |
| | | | EC43D7D04D4465FEE3133B0E00F74A3E25F23F1CDE19255BFBF3F6 |
| | | | E176F49F0DBB7257E52713D6E38AC421416E |
| 22 | 22 | 0 | 0x41BCF75850F7F507DE7BAF72440F81CCD6CBD39DF3F4C480B633 |
| | | | 72EB304DF1EFBAFFCC46ABB23D7F576652F046E046574ABB652A34 |
| | | | 5BE940AB1B0C41D180E5A69323AE1FC286B5 |
| 23 | 23 | 0 | 0xD1589BE6E052BF2F6454CA3B6544E7EC40EA0C52F1F1FCD9EA0A |
| | | | C848426C7CFD68954903E58207EA978A6FBDE339C63612B5D1129BA |
| | | | 47830C548B8D852D015AA21BA0744ED2859 |
| 24 | 24 | 0 | 0xE51B8551B163C3AEE3ED428A02B241591438C4258A827FA140318 |
| | | | DC6D0CFD972F7000B4E9A789CB77DB0CB8870668A525F8435E1B90 |
| | | | 9A151BEE848909D9BA3C7AEBA1777B22967 |
| 25 | 25 | 0 | 0x5C557F5FB89ED6CD24E3C47C02986488E0EC7541CBA57DCB86A4 |
| | | | 3A26407B84A29E2E5F8508D657868710BF5E9F78A8D1FF0454369527 |
| | | | F5C6360F26C9ED855A409937FBF64CE499 |
| 26 | 26 | 0 | 0xCFCBB5D7ADBC3A2E4056468E5DF76AA1CA194D4367B95F4B540 |
| | | | 048756459D31032746FED90E16BA7F84A502745F0C701A6AF19A646B |
| | | | 470665C4452DF6A4FB5BDA75E881CF983C0 |
| 27 | 27 | 0 | 0x726271597B24271D3E80A6ABE9AA8E09D6128FC43E8F97AB4F6C6 |
| | | | 032FF6958CBDC0E53B29EA89192464AF384C034883658913F51A36A9 |
| | | | FD3AC91C709231205C513ED702DAC05D3 |
| 28 | 28 | 0 | 0x78BC5870B4A4B7ACBC933F3CDFDBC1381B48774E9956DF7B98B |
| | | | B08DE15C8AF45D45539F1CDF354B7774AD1AF63DD9C0DE444EA38 |
| | | | 5B462CB53F42C1FB3D226926C28A107DED84C9 |
| 29 | 29 | 0 | 0x1E19E6FECF103B31B820A7444E248362790113C863DBB251CDDF5 |
| | | | 8CFDCB580F2BECD2B335227FB0EB7815FEADB3670438F6F2F158B4 |
| | | | CBF2AFA56FD55A121412E3A9FE3E576FA84 |
| 30 | 30 | 0 | 0x21D6E1D51BB213B6B752A3926DCB36F5992EB2EF44BE4E2448CF |
| | | | E526309BD119F59611E5988CE1AA177848F5541645F3C541098F9DD4 |
| | | | C237E8DAF3157BE9F8C000694C3F97D5AD |
| 31 | 31 | 0 | 0xCBD095E152AF83C914490C2FFFFD0E1785046802775B7418288FB1 |
| | | | F514CD7067B761A2A85D65A41D14C8D0E644B9BBA1298F3C4E95CC |
| | | | E1DDCDA5DC51D040644B1CC2897E90B6A9 |
| 32 | 0 | 1 | 0xE6B9D7C3D84283265DD2BEB35CED572A764DAAFC6E256ADB97 |
| | | | F5290057397D886B8128D26837919B82BB4F890F867563C10D5998334 |
| | | | 309A75045F6571D0BD1B205B7808299B8A4 |
| 33 | 1 | 1 | 0x8FEA67DB25D706BEE88FBAB3EFB735BA330BB88E275B5FC16812 |
| | | | 64C9FF2A20ACB90C496043E1FADA19E528C42D1FBB5D3F596DB39 |
| | | | A61EE806A09411DF8D5393B5594A39DFA5C88 |
| 34 | 2 | 1 | 0x67A14BB44D27CFBD286045AF19275DF9371E1E0A82C9BF39372C3 |
| | | | 2CB0B56D222B01981680547621BB8355FCA508D1626D00780771D61 |
| | | | AEE07BA98C8B3BF34367BAD63F791810F9 |
| 35 | 3 | 1 | 0x7A14B769AE708C67B88E835BFCCAF1ADAA20E97BF939CA1D176 |
| | | | 42F7D41E0FE9469AD5CAF130218AF768918609F9B959452CC9BB504 |
| | | | F06055A4AFCF68BF28206452059666E2B37C |
| 36 | 4 | 1 | 0x021B17A5956EB3BFF884073626A5B61D6A40E81C9289F5602C07A8 |
| | | | 831F006C4BAEB3865CA1AE6C578804FB21FAB4FF7CB4965E3E1066 |
| | | | 4B3844E138E721A3833379BDBC590BD6BC |
| 37 | 5 | 1 | 0x134B5888D3031F44C037B6A621579EEB9A6C20B70354DDA445164 |
| | | | F06216A91B29A266051606B8820BE0EFF998EE1E968F49AEA7159405 |
| | | | 34D3A0E479A2B-570F9CF8B52B895B0FE4 |
| 38 | 6 | 1 | 0x14C4CF64E81ED3A4E85D013CDE78A62A9155F9E14ECC981100928 |
| | | | 4A4F680E8A09CEA4D661E74F5EDA6934F531825A60CDE8A5F195701 |
| | | | A215DD60376F3FC12D1935559E273DF686 |
| 39 | 7 | 1 | 0xC590AF461D0C9176524FE6D5D71259AFC5E1183048EFE366224374 |
| | | | 90E053246B66418456F1891AC61BFF9557FFFE2DD633FC18383F5D0A |
| | | | C6F76B957601C697DEE2FA3C6128EEAC |
| 40 | 8 | 1 | 0x125BC0A5481A6BGBEF3491DAAD0FC66A93F44584836434952BE51 |
| | | | 8F336F84F3877278A738B9F7DD9F01D22BD9AB185785949D268195D |
| | | | B316E1AEC1BFCD0EBD602139D1F0B927D5 |
| 41 | 9 | 1 | 0x095634A7AE024A5561359DE32DF80520A391EC83C3882CFD123266 |
| | | | C64016A831A57266AE03D7D8CCD1C6EE2C48936EBE157DADC7226 |
| | | | D09C4810E7B3DF01C21D0FB6C313F451916 |
| 42 | 10 | 1 | 0x8859ECD4F4B7441448748EAA5D72CE38E0310474082207C65AD80 |
| | | | B4C9BAEA6D7DA43E853DCBABDADF11737944AED9C25794AC113 |
| | | | AE703253F53FFA40DF7363D56B4B4B11990EE7 |
| 43 | 11 | 1 | 0xBE1CFC64DE8699B8EA06E71FC8F4CCB682943B2F49CE12F00C4B |
| | | | 30448747A18A42B949B8D50C9998B32E7C324E3EA7D634C6E77092D |
| | | | 2A5AFD77C433B00A5F0C5D42AE46133B927 |
| 44 | 12 | 1 | 0x96A807FBB5C8DF0BDA41BB190E285F6FEB64CD06569B8555CA7 |
| | | | CC5C5FF5BE17AA59FF0C55BB95802AE679D45630F1B4BD954867BD |
| | | | E482ED109A7A045451E5B67BA6370D9BD3277 |
| 45 | 13 | 1 | 0xF98AA2BF925C7C063E41B29A77A4023A78E161DECEA259181C977 |
| | | | 95E396EE543C0651B22E1054AC1D204D0EA66366DB74D19D2038178 |
| | | | 96700B1A3BEA7EF33F5B7B4253D0B5BEB5 |
| 46 | 14 | 1 | 0xC2F0A0D16F8EECAB5BA57E873B1D09B2437CE5DE38D04CCB4EE |
| | | | 98126A5727ED0A1ECA79CC22E95D8B3E3FB489934D59C0BB1A6605 |
| | | | 3175AF2867C1C9734F5794AB45F4B05D94F1F |
| 47 | 15 | 1 | 0x56750DC1D43AA4AC8C3B7F7E3B31A682B087E28FADE45CF2CF1 |
| | | | 8972E43688827D651C434C0FF8142D45094A77980C4A0F729C0414F84 |
| | | | 59CBF3492F54CC8B7FB02917E793370339 |
| 48 | 16 | 1 | 0xB32AC0FB86942B7D0CE65887CF78DA2D5ADBCCFC72BA424E0A |
| | | | 51FC96E4BD3FB9B182C98ED07CBDF690B6731A48A56C766A2B855F |
| | | | 05A3EAA79619086C1E222C66ADD32E5823973F |
| 49 | 17 | 1 | 0x14E6173B5C26974F7B06229D82B3D2D9594382A65872939554858D0 |
| | | | 4B0A13C53A0387D83721F936F82C912748A75946B6E27D66DC880665 |
| | | | 556C33FFEF7155D0F1DFAE4566D829E |
| 50 | 18 | 1 | 0x107FBD983B3CBC9E2C4C7F4AE4EF8F50B2F658EEED9C90D79BE |
| | | | F725C1DFE51C4782CD2ED8AA68CB78156B62A04957218EF4B1AD19 |
| | | | A4D55A177423F985D4ECB74D93C8409CF8950 |
| 51 | 19 | 1 | 0x31076EE2C809D00514A761A35C71120C8563DBC12ED687BFFA1F7 |
| | | | 30408F20E29243E87459F11FD92176274B283756060B1E5A886115699 |
| | | | DCEDDD4273997B175A1CA1EB33592969 |
| 52 | 20 | 1 | 0x74EB7E0A53D666C78287C3BCFACFF186785A8335D643DFB12DB8 |
| | | | F6854298E0FCB0BFA36A68A1A33E04FE6AC00A439906F24B31E9449 |
| | | | 3ACAFB4057271D0C3658BF256E6645DFFCA |
| 53 | 21 | 1 | 0x69115CE97D4A82A88D8B201036E8B2A0B2FBC799CD12ACA1053B |
| | | | 223A2CBDDE67269F01284428DB37A5A8F502742B532F4498724438E7 |
| | | | 2E9873F03938F43F1B7DB91C87D5984CFE |
| 54 | 22 | 1 | 0xEF1E8CE6731B59EF60099C73344E27C8F2F09A5C52587512E24DA6 |
| | | | 9F6EB7E79969DF97F4BBA5D88A281A437AD7AF9E54082324B7407C |
| | | | 693C2FCE1AC581FF8993625795334AAAB1 |
| 55 | 23 | 1 | 0xB39B55F1F4C0D5312C7613395EB73CFBF9ECC61CD02FF18942BCF |
| | | | 3784E3E045D91587C154372CA83809F7663365442C5E37B63E0DDB73 |
| | | | FC1BF0829FB569A47BB31641E25F72EDB |
| 56 | 24 | 1 | 0xE2F3E274479133C076606948CB3D6A62EB304F76C810FA2A987696 |
| | | | 87C134E2EB90D0902AC18B1693381D7BB2AC498EE032A7BCCFD72 |
| | | | A50902F33F765353ACF5CDE50249BB5881A |
| 57 | 25 | 1 | 0x1DE9255ED07D57CFA62371E1979242A3DDDC435BC6E8C05B0155 |
| | | | 3A8F6287DABFDA52DB6E081BA23ED4E04E7A46F7CDA6244D2422E |
| | | | EAC60A4424A85461C8B06C9874BB7067378E1 |
| 58 | 26 | 1 | 0x642CC8276CAB5C693A88FA18950B09423820277A197DD2CB47D23 |
| | | | 6F3897BC501DA9CCD401A7C7FBEC557196781B3B3C15DAF3724B98 |
| | | | 99058140395DB3833424C87CB91F5D9A41B |
| 59 | 27 | 1 | 0x9A270A2147AA490A66120E2DC03D2930BBE5DD1CF5D39CC4C27 |
| | | | 3E6330A15954CF7CF193121F7FA23B6AC037E0299015966BDC9C70F1 |
| | | | 793D42BAEC2B481C5E9B971DEFCBF85C048 |
| 60 | 28 | 1 | 0x17291F60DFFABBAB43DD04CC77E11A9E9C9B1E262FA69624395A |
| | | | 20329F36F52D0D58CCD4DE50C8E7249BBC37CC28BD8E28E583F8A |
| | | | BD45233D682AFEC301A20A5F27A3B0FC51E56 |
| 61 | 29 | 1 | 0xC068E2DEC9DD2C0F34CCF5E4459405BBD7B169A792D4C8B25670 |
| | | | 01D4263A90AF3A4D0AFA61337857DE6FF1F0174482419AD58EB079A |
| | | | B5277514BA7BDE050111CD5D0A0724F420C |
| 62 | 30 | 1 | 0x9767D6CDEA30ECAED5D8FF07AF807D8CA840812D1745124A622 |
| | | | DBD0B4BAB91818CBDD0C9579FD0801C73CA17B454A2D2956698C3 |
| | | | 6FE99B1CBA72621114A5A15C84DDFA62CA1413 |
| 63 | 31 | 1 | 0x489D41353CE869C8A433B22D3443B7EBAC93CE1895AC3EA5337F |
| | | | 63ECD00E069E4AEE90A90E79588321797A8430B88888E260F8AF4C0 |
| | | | CE1F04FCC044088745C5D5B4C6E2937E8D4 |
| 64 | 0 | 2 | 0xA2330410704314D85FFE9CE571B0ED4927E5CCC6C689CE9A34516 |
| | | | D7A9C7981430E069E8A87E062484FE424EB58A45CD979031612BDD8 |
| | | | 22D29F789368760DA9D7419B7B6BA03FC1 |
| 65 | 1 | 2 | 0x496CBE4FA2A576B7DF6965574E760FA106BAC7774387C51215DD |
| | | | AE6B2653BCC8293D3D6CCC14E3CE753333AA453A06CE8C9A8BDE |
| | | | 2730C2C416817857DF1D9DBC19D9275DF181A2 |
| 66 | 2 | 2 | 0xB0916A739E8CDE11BAB56B22C6AB72240FCFDD3664C5F32EB00 |
| | | | C051E170C1FC1054B683764B0D7B664B85A8F929AFC5C66F0FF35C9 |
| | | | 3E62D2FDCA46F9523FBBD67354A27A2EA005 |
| 67 | 3 | 2 | 0xBA69F3694DC23AFBF407AB7C3591C370ED4B99268759EF64FFB32 |
| | | | B00EF234C7BD6D5C3D553DEB76D6E74167D637CD8CA445366E21B |
| | | | CB89C10BA0B6A10407C1627A257E6C6AF4A7 |
| 68 | 4 | 2 | 0x7C3B1C1AB29DF2C6155CE650D06CCADE3E5B8FE364A69A839B4 |
| | | | 01680ABB5B06A45C049605CF37EA1190B094AC0550C932C950F10D0 |
| | | | 88EB7F61245B87E656FD14F058895C7463A3 |
| 69 | 5 | 2 | 0xB4944E76C2A4545AD3A783B7137C1AC2532C502C66F1A0CF01C4F |
| | | | 665B9D9213289FFE734C1301069A630DD5DA89E07D1C9F46D46F48B |
| | | | DF09B1D374CE8ABFAB0E9FDEC1956E879F |
| 70 | 6 | 2 | 0xCB416FB39A094C69EBAE4688DAFAA2F151D122798E9B1A86AD2 |
| | | | A386198237F0C713CAD3DA8D8522821122D02F4DE8C2D235581109D |
| | | | 3B91EED818D1CD6B304DE98A7D9124DB643A |
| 71 | 7 | 2 | 0x17B29ADD8CEF49F4AB7F4EDA37C75C8F146770ADA2001CAC57F |
| | | | 3678061E8545CA139E5B4E9C1EEEEDA1A4941BE44A5DD74491C9D3 |
| | | | 58CA588FDF386E5C6A9BD7836423AB424ACF7 |
| 72 | 8 | 2 | 0xAF86BBC0376541B0DF9D45923A6B791FC1CFA03F659E575ED5623 |
| | | | 6F4A419C80DD44E1A5013AC6E051CCD65AE7B967B0B4B9EE8F2999 |
| | | | 1785FBFE59D3AF73155385163C98CCDDFE8 |
| 73 | 9 | 2 | 0xF174AD8DB7897C8D0C63779D120EA7BDA6DFD2C1CC85196B1C8 |
| | | | 60CBC53ECFDC451F7BCA61D97351687BB4CF2B242A3F8B50372A |
| | | | D45DECEF4A5891FE0C1C66CFB0E153B85836E0 |
| 74 | 10 | 2 | 0xC88AB3A1D2502EC9C5825D4926ED5A6FB544A64AC771DDC5029 |
| | | | C74AC7AA7E41600D434C83FB90D0FCD1D56B5D4EF5C6394A77C24 |
| | | | F06FB6E7D5E9AEFD9F0F6E501730B796900165 |
| 75 | 11 | 2 | 0xFF949FA0695B1597F25D6D408C570C519CA2E345D791C68D31D82 |
| | | | E6233B67C5996F6CF7670D1C8BF9F234979D1F32D66BD298C8C6063 |
| | | | E61763B6A54192E0D554079CA7A12E8126 |
| 76 | 12 | 2 | 0x6C2B403A72832632653A9CABD85E32C687C7EA50775B40498BA84 |
| | | | BF9121108CE07F8314B41D6B1F8CAC7751FB78CA4134380A049777E |
| | | | 7578F0B0A924349BB2F2312379D31C27C5 |
| 77 | 13 | 2 | 0x56EB0F1593B218BB43F806208D9CC7EAC2B0CD24DE802BCEA24F |
| | | | 6D77C91707A8E5CBDA375E16A7B6EFA2872E45E28FBE381CB40D4 |
| | | | BF9C86F54656EA1A19DB5ACBEC0602D9CC9F1 |
| 78 | 14 | 2 | 0x6F443AEFA2562FDCA7E62FC6DD089397E98D4AF0F951540E9D9F |
| | | | A4F7D603E34EC19A77B7F034984DF7ABF880274D125AD31C2B09171 |
| | | | 818140D137DBDE9ECADB7B44788A460A15B |
| 79 | 15 | 2 | 0x6B09E912415EC4D976F3E4E120075FCB55B143F4D7FE6D754E5D1 |
| | | | 9EDB6A2466BAFD3862C6CE32410C14EEEE959E608A45AA00798744 |
| | | | A794BC3A26B33572BBF47159C16C287B289 |
| 80 | 16 | 2 | 0x535045E6A1BE6C3871164C04917BAF3417717B7BA8CC6F108BA3C |
| | | | DF93D140EF636FCD70C14CEF825700852993A6F481473D6D0A6AF5E |
| | | | 2FCA7DA7D8C528917480D71950F3907845 |
| 81 | 17 | 2 | 0xD6C4281E746D6994EA30ED6906D65F7EB3B99FDA7ECE3EE524F3 |
| | | | 54473C519DB0B3B5198509BA2FA64CFE2480503FEDF221E3A0E8F5B |
| | | | 43A92067B8BEEE889B2EB995A27594F8876 |
| 82 | 18 | 2 | 0xA10FB173C3159B2D26FEC4D9F1708E53A8AE682563C50ED3F451B |
| | | | 2B1CD410B64555EB54A508C254CD5FAAB657DBFEDC793812CB6A |
| | | | D6FB186D095314F18F1BB3DB86CAFE83F1F97 |
| 83 | 19 | 2 | 0x43E2FCE6BC77FCEC0A1797265E24B5B9F3073EC91FD21D6F182D7 |
| | | | EEBB127C7A73D2F779FD4FD25107A53376C29A9E54432532BC16855 |
| | | | 02907576AAEBB70BE8EB80848E2DC3BF88 |
| 84 | 20 | 2 | 0xDAAF7CC412910E3AC2F46BA03A2CB5C9C102CAAB280B5A9B30 |
| | | | CF518C8B452101D402C064FB582678EADC7FE8270DC729C86C2F7B |
| | | | A7A27D7D4051D20E5BED0CECC48903CAA21E17 |
| 85 | 21 | 2 | 0x51A1B3581F09E6BDA9F6F488306C682FC48FF0340632D4BF25A682 |
| | | | ECA503AEB4640B5A629F1F5F64E7D95917EEF0B292287F0C406306D |
| | | | D2331AED66675E78C8B5F4B9F4C976BB3 |
| 86 | 22 | 2 | 0xE8119205BC780C24AF954FB7D79FA19299AAD973CAA3B79498BC |
| | | | 84DA615AADBB13EC41D3DAAE9EA7BCCE320670E01FB662A08FD3 |
| | | | D86A22B82F8DC383A14155B5D3874427B40E45 |
| 87 | 23 | 2 | 0x79F1AB5149FBBCD517C5D05D9A75CE1B1E359B008FE87051F9649 |
| | | | 7BED050DA20AF85AC72036E606C5FC13B74A1EC67C78D619EDC64 |
| | | | AF67E9B5A7EB19E4A4558DE1FB3BDEFE122A |
| 88 | 24 | 2 | 0x93C52847F7CEFE85A2A83CFC1D2E06E213BA213B16C6DE49157B |
| | | | 914E5F36904861F1A78D60FD6534E78356CDD8CFAD7DD0DCC4D727 |
| | | | FDF7A12875823962DAA9EF9507B7E455862C |
| 89 | 25 | 2 | 0x2321F2A38ED77AA84F21A050F5D437F6828EFF9AD41C08EBAD36 |
| | | | CC8C6892D12CE28EA1897C09851E896F615E87F9C1E8BED6FE4833E |
| | | | 3C73B91DBE8B10F627800CCD741F2FDDBB4 |
| 90 | 26 | 2 | 0xBF12B94B7CE138579A1DA5E022ED498EC66F8157DD213349EE834 |
| | | | 49D9EDE3C9E019E2B0791BDEEB5FAE72A5ECAE4AF0F08521695F71 |
| | | | 8D76EFBF303544C1ACAA266F8022A24746E |
| 91 | 27 | 2 | 0xDA5395D54C16ABA1FA3CF32AA0A56000E075AC194D8C3D40654 |
| | | | C83E690D13FF18CBFDE29D8C311C1BA49BF39308BD1F25ACC6C99 |
| | | | BD9A9C5E65021E7FCF983D78E0E9D236DDD2EF |
| 92 | 28 | 2 | 0xEE405CA07D5EC52856AD91BFB9E8ADDC0C0D21D94B4CC21F159 |
| | | | 3C4767D0E1A1DE6159DB6402BA2BEB18FF25C3229A024D1F8E7B02 |
| | | | ABAD99BE9D11C9EA47534962A53CF4CFC9260 |
| 93 | 29 | 2 | 0x0517BFDADE441B914660DD5F8C50B938834848A55A94950B25DF2 |
| | | | 0CA2E83791B441FCE4C6B2B44DA6CCBAB470842B3DA3F1566C780 |
| | | | 66DE1850FEC90CD4BF86684588403C5C5113 |
| 94 | 30 | 2 | 0x3A12B27A39D5781CFE30EACF421535471B18A87B7F3E7FB933BB |
| | | | AB544EECD5BBD11801A573B26B830C64CA2F69EB0476BC0EDB925 |
| | | | 8974CA50D8F6DCDFA7F21A3CA949563AC7815 |
| 95 | 31 | 2 | 0xF77D8F4485053CB978A8B944D8399DA3440A9F3D0B87D5BFC82F9 |
| | | | 7F3940429A953F429FE47CE62BE2A516B1412D4C2CE804D73CC5139 |
| | | | 1CEF47D7125C65F566C554A7CA38330310 |
| 96 | 0 | 0 | 0xDD183EF9D8C8AE1669D517F5293EB2287786BB2AC68126A1D3E7 |
| | | | 186EDF938054B2B0C0E34F71EA3B7A394420C1A798D6D26010A25A9 |
| | | | 909302E12D7C0199A7B98D564C5F4F72EE9 |
| 97 | 1 | 1 | 0x705E5DF32647E7CB92E918187DD0DDF468ED96E4E5229EA2A30F |
| | | | DB94620AC7244939175F8D6CAB017F83CADDE33493BB0BB030AA0 |
| | | | B45671AA7DA90799ECB6F13CF9FEDE29BDF9D |
| 98 | 2 | 2 | 0x4C349512091531510C4985212760B795268272DFF3AAA7BA92916F3 |
| | | | D5A04231EDF8D443A2EBA216B2ACDDB5DC503B3000A70F339AE38 |
| | | | 4466D2C8F683375E81E174D02837A870BF |
| 99 | 3 | 0 | 0x43CFB08B3DB7F763BD3BBAEC9AD5B6382E5D277AFA57B6134A |
| | | | E9F4CE12EA233D01CC1DFD73E04CC0E91E1118975F1D31586210886 |
| | | | DBCEE8615AFD6E5AFC10E9D1127BC697EC414 |
| 100 | 4 | 1 | 0x60E316DE1632E1B10BFE584625F13019403A4C25AB82563957D532 |
| | | | 75B6A82259416F74452F81A655F95A4A75C3D9C740EFD04F3A31AA1 |
| | | | 72333266ED92E369E78B49539F2BEDC40 |
| 101 | 5 | 2 | 0x63CC58882733C9D36F9DFA47E84E7B53A33D4F312BAB66D8F0C4 |
| | | | 04B551F8113331B4FD592423F9DB434D15D7258A0625BAB9BC69EB4 |
| | | | A37804D7E9052654720A3C49656967AFFED |
| 102 | 6 | 0 | 0xB07DEDF62ECA8B2DF3E62B67D38C7306B31D6586AD23B3EEFA1 |
| | | | 9B3F910A41AA240F3470F5BB89237D494E312F87610C94FE02700877 |
| | | | 76D8458F715FD7E242320AFF07FE9550E16 |
| 103 | 7 | 1 | 0x16466F71234B7FC9A64B1A82A8FAD35A686587DEE487F1314624A |
| | | | 39EBF8107002AA7E042DAE09C786668AB36F1DF6D58ED81EC22896 |
| | | | 01E181D31D5032ADCC4AACF23CF08C66289 |
| 104 | 8 | 2 | 0xA9B7EC62E60922C11A1AA3A94E3BFE7F2DC8B590D98434FD1D78 |
| | | | 2DC990807F9BCECCE95D0572A3AC64195528530ECF22158C967A696 |
| | | | 01DD777F591E96D8EEAEC3B6DAC49D71FA2 |
| 105 | 9 | 0 | 0xFB225E61BEC51FF3F7391C1ED0D602BAA6680B23FC7602B65C023 |
| | | | 7BCD13AEA392CD06BEA614E3D2AD5CBCC01FBEDF59E0B16230D7 |
| | | | 04489B0EF58E7A541E3AF22621118D2E9E55C |
| 106 | 10 | 1 | 0x917BF984E97504B06C18A6A36463722F0936F759B34F8C947C42179 |
| | | | D3298B357EE963F5565405AD2E942B709772B2FAE10D1A8B166E1DC |
| | | | 5FDADDD1188783BD96E5318B202D0288 |
| 107 | 11 | 2 | 0xCC7B5A30AE497F10EA9B918197D9E6AB754AA36B8E179F3D8DB |
| | | | F6DF1861BA81E401ADBC34CD119D75307EA941ADD6B4A367F04FB |
| | | | 2BD014A367C1FE1A6EEC5045CC3C7361EA7D6E |
| 108 | 12 | 0 | 0x63CA535A600FDC5D15160C215EF273EABD052519045A0631677666 |
| | | | D6F8389EE3D0D7D9AA8F694ABCAF9B12BFBCF7D1698D9074AB441 |
| | | | 9D4004B66E3A9F415688D6E70A1B43E9ACC |
| 109 | 13 | 1 | 0x0243EC00FC656AEA6BCFD70CB0BC6A761610D3F4099FE1369CF8 |
| | | | BE663D99DCE034D54A6837ECBA2A1A1A95D1F25C63913B0B3127F |
| | | | B6722BDCFC0815631EBFF9B2116DD4788D291 |
| 110 | 14 | 2 | 0xD95D3238896B05B21DBABC0503B251308C505EAF7E3CDBF89289 |
| | | | 11B3E0B9CB91E3766C285C30E0B98F776BD065A56F9697DDDC6D05 |
| | | | 650AFF036CD580117C224A179C90D1CA10BB |
| 111 | 15 | 0 | 0xDDD2160D107CF8FA79E0A2EDC7215683F3209EC3B3A40A7966CA |
| | | | 8B84E57B343A868415C086062226A45A4DAB4766F2925362397EEA96 |
| | | | 7EDB0C879CC13657A4420A6301CF725FFE |
| 112 | 16 | 1 | 0x52A8B29EF02C788A0CBF33F90FEE131C85D4AA2CF058B1EB4C64 |
| | | | AD870A93C6DF7D0A63E44EDA8F7B7CDCF1EFCF6603439E8992ED9 |
| | | | D98459FD786DF9C54DF621BFA1B38B5310651 |
| 113 | 17 | 2 | 0x6F0C445BFC5B6037B49D6C20776018B247740079B9C3FDED22F427 |
| | | | 19408AA9B189E77E0950518DC5DD1614CCB1CE9360B46CCD1D8F57 |
| | | | B93DE3F89DF3CFFA7F1DBD03256A853AEE |

TABLE 2
Associated amble modulation series per segment and IDcell for 1024 FFT mode

| Index | IDcell | Segment | Series to modulate (in hexadecimal format) |
|---|---|---|---|
| 0 | 0 | 0 | 0xF57DB50BE77E3A60EE76D67CA7912007B418F8D33CAB27CC8B |
| | | | EE622187A14DECA294F65 |
| 1 | 1 | 0 | 0x4DCF800E623CC52D526BEF35135AC796FAB629EFE345BDD17E0 |
| | | | 54367462FE7DD384C166 |
| 2 | 2 | 0 | 0x76319FCB87AD5AD97C07B5609356A2E03F86240A071F571BD05E |
| | | | 8893734EFB4D0CBAE38 |
| 3 | 3 | 0 | 0xBCB170FB690620E5CE525BFBD9D42A0B08DCF9014644338DF20 |
| | | | 8E44A59633E53A7459FA |
| 4 | 4 | 0 | 0xF4C0C87638974E6B9A86902AD795389E7FD13D81B42C36F24461 |
| | | | DD21B1C8189D5051F41 |
| 5 | 5 | 0 | 0x3FAC0F59F5FF630D04293EB7716C7B0E51779234B31E2B09F7A6 |
| | | | A8DDA8F3321D9A7E477 |
| 6 | 6 | 0 | 0xD3D4D13A11ABF7C26DF4C80F48FC3C9F2238C9FC9BDCE72F5B |
| | | | 3DE89156538B1475AFB83 |
| 7 | 7 | 0 | 0x1245C650F191AA8423A4EA0F857DAEA95FBEA3129DB165A2EF |
| | | | B69640607CFEF3336C53F |
| 8 | 8 | 0 | 0xA5DB1A1F774254A34BA32EA7B0B33FF8BA8F19E248B758A8D1 |
| | | | 3105CE22E267B18E0D240 |
| 9 | 9 | 0 | 0x1C4FF0F128E91AA45D52D8628A49F92D32DD8B1DA1620D3590C |
| | | | DA57D4CC05AFC33FD72B |
| 10 | 10 | 0 | 0x7B5B62AF67A90684D18BC1F2A19497CF1CE2DE27B8BE6DD5C0 |
| | | | 37BD8B649D7942FC84577 |
| 11 | 11 | 0 | 0x8E25BC255860AE02153889BD9EB43C99D709F3F75DC1D1591103 |
| | | | 6FBA20CA4F95F6C0C03 |
| 12 | 12 | 0 | 0x93BE3FD5823BAAFCB4AE7F9EEF3578CC0636CD2A4E9A0E3327 |
| | | | 9450DFE2947A744371678 |
| 13 | 13 | 0 | 0x772C7DC4F03B241636BA3E9E8ED149EE308FE92B810A64D20A2 |
| | | | 355AC0F2C205AE7EA5C6 |
| 14 | 14 | 0 | 0x8DF96F103B64854FAB659F8C730D44A3DB54424F82BB97B1F6BF |
| | | | 1A38197B68148623EA3 |
| 15 | 15 | 0 | 0x4B2086A873E39C150597E16C0D7622A733DFD6CD88E324CBCCD |
| | | | 91EE8B7E7218F56A41E9 |
| 16 | 16 | 0 | 0x3F41BE94B4AEDF3E16F53E3AB8A1599A90789F1F850DBBED730 |
| | | | 260A8CEBBEA8C4137880 |
| 17 | 17 | 0 | 0x3CE9A79F2302E457400675235B4020663DA63BF0EF13A1B6EC517 |
| | | | 0489DEAFED7D417B63 |
| 18 | 18 | 0 | 0x3E43B35C0FC8E3B63D737601E9CF507A942416F6E071C064086E |
| | | | DDA79D5F9F6B9492E32 |
| 19 | 19 | 0 | 0xB912FD155BD05114BAA6B95BF9A63D6C3189363087AC8FAC580 |
| | | | 0182CF0B2C443A1787C8 |
| 20 | 20 | 0 | 0xA224AA7DD3F3FB16D7D076ECC81DF38C41D826F11E775938949 |
| | | | AFBE58F10F2F1B4F52BF |
| 21 | 21 | 0 | 0x6EA00D7273604A3ABF93E128C5F64092F61C0AF80E0B17A77A4F |
| | | | 463463055C925EE3DD7 |
| 22 | 22 | 0 | 0xED755C6EC155D54E99FA627B31BCC15C3FF46B63F4FE184953B |
| | | | 5E1A421AE179F6C9F2C8 |
| 23 | 23 | 0 | 0x5042051DF29A85D7A7808645D4CF37E0B6C6E556FF014B6652D8 |
| | | | BC6CCE3D0E60E5B8B3C |
| 24 | 24 | 0 | 0xAE2B94E46A91E7445B41A392E9807CFBDB9638BC4ED815A1F19 |
| | | | F3CEF6D43EC94D694189 |
| 25 | 25 | 0 | 0xFC165FBF1778BA85310C2B929F4A91ACED44A11B86DCD87586B |
| | | | 12FA610244D1D819C4C3 |
| 26 | 26 | 0 | 0xDA0F1AB3D1F1AE7CD322DEE221424D22522C36C06E6B89EF697 |
| | | | 313A30A4DDFA5F6528AE |
| 27 | 27 | 0 | 0x4A8AE9AB1A5AB122872084B6A2CDD541F621F1BCE3E60B07933 |
| | | | E303785FEE97637FE321 |
| 28 | 28 | 0 | 0xC48A06BA315D19759E1F226C57FD66BBDFD35E1380AF44298CF |
| | | | 5E6070561DEE43F58212 |
| 29 | 29 | 0 | 0xBF4A84AE6E8B0FC919AF9504C84B7205B46D0CF9BFAB5968967 |
| | | | 3451C89A2718CE157ACF |
| 30 | 30 | 0 | 0x021A957B126CD6DA7722E0010D701AFC1A1985E855E4BF9D4BE |
| | | | BAA3BCB38E9A3ACFA305 |
| 31 | 31 | 0 | 0xFBE0BE26A6EC687FAD70876727BEE7D133308A0A8C56735C76E |
| | | | 0FDB4616AD9B5CCBCB65 |
| 32 | 0 | 1 | 0x10EFB2BEDAE303304F2B4371B4BE5EEB2B518BFB46D176CFE8 |
| | | | 94C0C1A657040F1B9214A |
| 33 | 1 | 1 | 0x099BD0769A5DE0A03E10A6A73C17FF5D875EF6E0CC65FC7A986 |
| | | | 05867E37B9044A85CA33 |
| 34 | 2 | 1 | 0xC67B78718F368D1C5E2D0023ADFFEAA5E55A4764EFD4DECDB4 |
| | | | C7F428D95334C7E519BE8 |
| 35 | 3 | 1 | 0x217F1C616A21063829BF5227EF7EF95E592AA7BD66E499A42BD |
| | | | D721F93A9E347E315DA5 |
| 36 | 4 | 1 | 0x5D7D60E9D3600CF86763A899BA9F1505C9279865B6C0E406C758 |
| | | | 653AA4696A51E7EA7CC |
| 37 | 5 | 1 | 0x409F8ECF8A0232132ACF9E61756E95F902F2D8D5D70898A30EC3 |
| | | | 949CFED9590CE786990 |
| 38 | 6 | 1 | 0x3B59394CB93E72A1C84E173D44DA313F70C85A2D905222F6D03F |
| | | | 3F3907E3CF75D79510A |
| 39 | 7 | 1 | 0xB021F589CA6B5C62A0DE895DF3A43EF68B8612ED3D5D3E0DA1 |
| | | | 8A4AB527413B3D9F77355 |
| 40 | 8 | 1 | 0xA7FEB67C8431AE5ED54B09B3CD745BBE8BD6621787772DE2777 |
| | | | 7E04D5BA485A335060C4 |
| 41 | 9 | 1 | 0xAA062F840EEE49958150CE164CE3D605797BA0305CD8A5804A04 |
| | | | D8F6D15BDE6684AAA53 |
| 42 | 10 | 1 | 0xBB1D46DE51223584008E4CA3CC1F231C151232B2962BB85A158 |
| | | | B1FF63BE041F453FB5A0 |
| 43 | 11 | 1 | 0x9FF11B1DA431E3F4BAE2CBB4C4F0054FA3C000C1511CE84AD1 |
| | | | F193B48EDEBC448A93184 |
| 44 | 12 | 1 | 0x14542B2DE5628C0981E18A95A13EC1CFDD48E7B6664B1F6A8ED |
| | | | 1E6F784884EB24B29D9E |
| 45 | 13 | 1 | 0xC85F81AE4CA240963C58C9A7CEC6A1F01945A3F634D208A3C1A |
| | | | 35388027BD656F7D551A |
| 46 | 14 | 1 | 0xF9F8D3F91164BD5F5EEA2955A664F120CAB2284541B6B52DC476 |
| | | | 73F6871CC718B58BE42 |
| 47 | 15 | 1 | 0xA42734D4260EF4BA08AAC13ABE1ACEBC028747BE586889F6D6 |
| | | | F0758E2445A832707FECC |
| 48 | 16 | 1 | 0xBF3DA6E16206FC62BFC5EA8207ED6B1A3818CD60A69972F9B7F |
| | | | 9CDB9356CAD88C553FC5 |
| 49 | 17 | 1 | 0x885CAB55BDDD9E89750DBBAE1198C9C873E66CA60B8D071286 |
| | | | 1D92E525CAFEAF8BF212F |
| 50 | 18 | 1 | 0x4C6CC4642A1BE02FB068936CF79A1F94B52B0FAA110E71686DB |
| | | | 913D46A120678F3797C5 |
| 51 | 19 | 1 | 0x95BC1DC313D2B914D0DF070E480DE8341988243C50DC666B3D5 |
| | | | 7291455FF8B6EC98A091 |
| 52 | 20 | 1 | 0xA07D52A689936B04C73051B3B9712E003FB5B9B5F110086B72D1 |
| | | | 4E6F6FADDE186DE2190 |
| 53 | 21 | 1 | 0x3AC8751ED340FC6EAFF6408B9FBF9B92BF88F04B86B29387DEC |
| | | | 39A6C8C698BC5075A14C |
| 54 | 22 | 1 | 0x7C5BA9A36893DB8563D16338FC45B095BD63A1EDCCC68EFBF7 |
| | | | FA2DF5AA2B0B2CFCB9600 |
| 55 | 23 | 1 | 0xF1BB4E916F70576E60DA403E36086BFD4610384206F23E33585AC |
| | | | 3E781C9C53D15EE955 |
| 56 | 24 | 1 | 0x98BA49B9EF848DC0F5AC69A16D6967CAA0947DB98C001030920 |
| | | | 76A7D5290E923A2E08CF |
| 57 | 25 | 1 | 0xAFC405C2D91C7E2F6386EF5B8B04AA5127C86B0F6E5C14C23EF |
| | | | 6FE3BFBE39D0ACBFB269 |
| 58 | 26 | 1 | 0x0860019913383C35595C0746867F4434BF0A5A6271BF5D42936AD |
| | | | C33AA2514B11DE6EB6 |
| 59 | 27 | 1 | 0x2AE39A73970FD2CFF7ED59006335416D681C743ED2EDA81F4128 |
| | | | 37609199BC5363892A3 |
| 60 | 28 | 1 | 0x013EEBB7D1091D37815A85A3BFE676F3E85D3F6F3975D6441B5 |
| | | | A705C9B9870CB4C771B6 |
| 61 | 29 | 1 | 0xBF02968EDF90ADC62BDCB887387B27B3890F4D5676BC4E2FF67 |
| | | | 1829245E32EEFBFD1F19 |
| 62 | 30 | 1 | 0x84B3900D7D3EAF6E46B2CF9AE8650E479333962F95E95F9EF8343 |
| | | | BE3D845FF1B5D00CA6 |
| 63 | 31 | 1 | 0x06C7985575C7686968633D4F8E423F3C9D236BB617B0FF8979C20 |
| | | | 4EDF23BE5AB6DD6CF6 |
| 64 | 0 | 2 | 0x6ABCB0B37CE1A318129EE58BF1DE143B7FC6CD6EC5E20B9972 |
| | | | BB56C03455150E300DE4B |
| 65 | 1 | 2 | 0x2BACF5C40ED7E3461C7438552E43181F3C8E582457D497B6E9B4 |
| | | | AE034D8CB1B773BBFE7 |
| 66 | 2 | 2 | 0xACC0EC8C3A8DC8CC11424F46330621C1DA6AC35E9D357EE212 |
| | | | CEFB92A0CB4402A92FDE1 |
| 67 | 3 | 2 | 0x62E292288C30DA44ABB4EC6D42E5000D3BBD0F906427AF759F3 |
| | | | 276E3C8F27B7D0C1BB41 |
| 68 | 4 | 2 | 0xA29F1D5F6DF92FDD2DB669E9BD21CAEE684A159EF1B9E802FE |
| | | | B1C9896AF8762F3276072 |
| 69 | 5 | 2 | 0x6E3B15CEE3C2B7F5262EBB7EE3B53440D6856BB40120390B09C |
| | | | DBF0E67A596A2CA26826 |
| 70 | 6 | 2 | 0x898AC72500F925C02841A5D699C39393B3EA0C1F802129A956528 |
| | | | FE06DB95581596E1DF |
| 71 | 7 | 2 | 0x70E0018C8AED264C6BFB5BA82F13674134FB95F1837C38AA1E6 |
| | | | FC6339EF2D02F6B08EEE |
| 72 | 8 | 2 | 0xCFDC022326523C0C8AFCAA749DC32F47AF2675B074A75A7ACE |
| | | | 7ABFD1C43C9FDD698FC0A |
| 73 | 9 | 2 | 0x34E9743863160970282902E55D45C0D7FA2099E66CA7BB9A5AB9 |
| | | | DA931E666A291652BFA |
| 74 | 10 | 2 | 0xAB05BC5503E7FF47828EE648DB849BE9A32D5D8678DA673F12B |
| | | | C6B57BAD13023B21ADA9 |
| 75 | 11 | 2 | 0xBBF9AED7FA76505E27C6858A56B479F831A9C5F8B8F5E51CE7D |
| | | | 051DB2C91336D5C6EA19 |
| 76 | 12 | 2 | 0xB17EA958C03B6EDEA9B011DCE838756D90C51FDB62E6386BCA |
| | | | CBD619B5C29B00FA2B1BF |
| 77 | 13 | 2 | 0xF9C5192E52732F6025A7E064395F91C0445F20CF7A11E8214C9680 |
| | | | 458DF76F2CAC4C275 |
| 78 | 14 | 2 | 0x2C7901BD86AB137D27F57D3984D07A76DE2B996F559F47143129 |
| | | | 9D32187DC919EAA04A7 |
| 79 | 15 | 2 | 0x53BDFC1CC1BA48D75066CEC7FCA7C109C54484C783B0E0C8173 |
| | | | A96AB6CB1E28296B88D5 |
| 80 | 16 | 2 | 0xB570272C736EF260A9A50A6CBEC77A12FD2364F4B36FADF3A8F |
| | | | 9FF60488F8F623905118 |
| 81 | 17 | 2 | 0xB47BD0817141FD280E0B4A9C36F161758DF2FAA8F31C32AFE7F |
| | | | A23B736A59CAA47B38D2 |
| 82 | 18 | 2 | 0x3D9BE5016D23924068525DE6ACEDDB321727C5F56AB91C35788 |
| | | | 6C7A6179E15631F15368 |
| 83 | 19 | 2 | 0x1AB1EC934DD376A781B495CCBFB55800ED1C19B1F4EB582DE4 |
| | | | 06E281E174705510D4B9C |
| 84 | 20 | 2 | 0xF28BA38C44B2F7CEBC3BA741F620B13A3607C625979FB78A8A5 |
| | | | ACCFA48B52B013D1A431 |
| 85 | 21 | 2 | 0x9C9B322697713B5FB83CB323B14359CA440435C5E0FB712CA39E |
| | | | 8A1AA4136AC63940582 |
| 86 | 22 | 2 | 0x44ED5C4AE1DD7952DD73799FCB5DD4606F01ACB3A3E89FDF23 |
| | | | 7DFDC8920197D3EE50EB0 |
| 87 | 23 | 2 | 0xAED321C43F2A8D9CF2CB69227DC8CF98A94DC29D3D0722B737 |
| | | | 8F2D227BF9F8090C50056 |
| 88 | 24 | 2 | 0x76E6F62939F70CE294B95531E88174F20BFD3EE67F0587F4948324 |
| | | | 3FD567D15E088ACA9 |
| 89 | 25 | 2 | 0xEDF18994DD4D35B5E7B96ECDC7745D86BEE4326EA8548203EF4 |
| | | | D63CD078D9BF0E284F80 |
| 90 | 26 | 2 | 0x9CF78DD61DB73E67C6BB08067FD6A70501D96269A533EAEFB2 |
| | | | BC5F02296CAA87FD51EA5 |
| 91 | 27 | 2 | 0xA56652AF76593EDBB1D602D7A02603332E32EA9AA362495168B |
| | | | A7BEEE6C18C0D5FF3878 |
| 92 | 28 | 2 | 0xE7A04246C139FE36CB52BF629F8A9D1E9D90A6737174492F520B |
| | | | 39FACE59853439282AC |
| 93 | 29 | 2 | 0x41820D977E5A1D8F37DF2DA4C1CDC714E8A35E69514F998C05E |
| | | | 9182B0BE2A57B067E45A |
| 94 | 30 | 2 | 0xF45CB6737A83AA1D8CA788CBC85991136FEA29B9BE4BDEB506 |
| | | | 08A1DC7F081D68DC5B21E |
| 95 | 31 | 2 | 0x95F5187D25AD22ED14DEC296B9EADC606C81CC4A912B81E377 |
| | | | CBC8315CC6E9EA63DFBEB |
| 96 | 0 | 0 | 0xF3E1DC03AF64DD7F3672AEBEC1B6295FCEC5A1C9945B5207A4 |
| | | | 66414AFFF959CBD64F586 |
| 97 | 1 | 1 | 0xBE18E3D2C24CF06B72683BA4CE070AEF229017AD4EB02F6285F |
| | | | 53A6557DBC9DB3E9BEEB |
| 98 | 2 | 2 | 0xDBB35C45282D66FB0D62BEA28FF12503F5B27FC07E1D5F3183B |
| | | | D9C38392F5A6539B94A2 |
| 99 | 3 | 0 | 0xC6457FBB3B1E32FA313D8917250C09217C7DA77F50AB0CE385D |
| | | | 7886B83EA55B864035CC |
| 100 | 4 | 1 | 0x932EF9D473225A9F6921F17A451F051FB78EDEF6A5B989B994B3 |
| | | | DC0F21540F20E312B7D |
| 101 | 5 | 2 | 0x7B9E74C5EE4A27A3B488CB5087CA8AB4DED21E44660EC528060 |
| | | | A9432D2FD740907D3370 |
| 102 | 6 | 0 | 0x6C5A3D66BEA2103E9C46F4A6539CDA8ABAF2BCBC99F607AC4 |
| | | | ECB4559BFBE3911EC92D3E |
| 103 | 7 | 1 | 0x88B7F6AC76BB9EE6FE8F3F0F122699547AE334742BD38700FDB7 |
| | | | CD691C2363536FC4FC2 |
| 104 | 8 | 2 | 0x5C7C77ED3522C680859D472A72D01EC690DEE9F9A9B0D87F3DC |
| | | | 0F7D16A523DF9045134E |
| 105 | 9 | 0 | 0xC2FB6923D745E871A0C669D1011A51BD50AF591A9DADB3FFDF |
| | | | 295921E4EC3B0A79D75EE |
| 106 | 10 | 1 | 0x734BEDF2FBE961C5AD6E584EDE3FF1E2B416881636E97AC63A8 |
| | | | F755527FEE0913C48E66 |
| 107 | 11 | 2 | 0xD9D63B97EBF821DD019E22D0149ED8CDBC606159D5151749CC0 |
| | | | B56E7D0DAA7D93A36BD3 |
| 108 | 12 | 0 | 0xC132576511970E9C4530BAA95B8E53E13A2296FF8B5B2DC60A6 |
| | | | B1BE661393CD1F7BEBE3 |
| 109 | 13 | 1 | 0x7190B71B1CAA6F2FEDCFAF097405798BDCB5447393204E8C437 |
| | | | D4D306A79F49BD5624DF |
| 110 | 14 | 2 | 0xB0F05108B75D27A5EF0AD1053E5C90CA81BB9199263CCFD4D00 |
| | | | E43FF1BBF4E29EA2E794 |
| 111 | 15 | 0 | 0x13C5310837C749B9AC20C11DC0B71DABFD19DB401A9797C3C0 |
| | | | C7DD2D7EB336B1B94FE45 |
| 112 | 16 | 1 | 0x6E31118A654962412D16BB6283444BE8390F11AF280ABA3D67D4 |
| | | | DC7FE4C005F6470E7FC |
| 113 | 17 | 2 | 0x9AD96CD25DCBA2C9976AA272B4E3757D475F8168ED7DF7F397 |
| | | | E34FF38011A37E0C89782 |

TABLE 3
Associated amble modulation series per segment and IDcell for 512 FFT mode

| Index | IDcell | Segment | Series to modulate (in hexadecimal format) |
|---|---|---|---|
| 0 | 0 | 0 | 0x4FADFFE80EEC2353D5E0D719E27165A726CC |
| 1 | 1 | 0 | 0x689540E03A9813D746D411D6F5A34B618636 |
| 2 | 2 | 0 | 0x7EAB49F0D40012E30F6889469B8E4CC8DAE2 |
| 3 | 3 | 0 | 0x20E1BD2D774AA4FCC71967D487C2132899B8 |
| 4 | 4 | 0 | 0x3B75A75918A6046E6CEF1C045B7461A0FC06 |
| 5 | 5 | 0 | 0x70EF1EF0E5EBC1135B7D5C6A2B3296621B22 |
| 6 | 6 | 0 | 0x631CB45B105A839120141FAABE6E062E9DB0 |
| 7 | 7 | 0 | 0x3D140B4B808275866786FD39818CB56F99B4 |
| 8 | 8 | 0 | 0x4D3EAC3F93F3183890313FA5490C479D116A |
| 9 | 9 | 0 | 0x71C9D4DA13243705C67A34272CBBB4008F14 |
| 10 | 10 | 0 | 0x58A42AD7B2A9B35C7A61C9ED377C0DB80B08 |
| 11 | 11 | 0 | 0x7C7805023CA85B2536A49744D6BC646E3144 |
| 12 | 12 | 0 | 0x570826242964A3D970197519D8B53461DA3E |
| 13 | 13 | 0 | 0x49AD9B551D5D6328C67468383F40083485FE |
| 14 | 14 | 0 | 0x1D40D60A5254D9453EA19B9BA7C1005EF334 |
| 15 | 15 | 0 | 0x39C144E4DA882F6897AA3442361FC2FAD6C6 |
| 16 | 16 | 0 | 0x753A6EC9E4F3650158A11AD89F282D23840E |
| 17 | 17 | 0 | 0x292FA6D9EEB9380C51C64207E10CA9C5C588 |
| 18 | 18 | 0 | 0x1DCC7A97488252B60C39A076D147602365F4 |
| 19 | 19 | 0 | 0x21FF46D567A04D2F235361EBF18D32AEFEF2 |
| 20 | 20 | 0 | 0x07A545581C96FBC44CA579B589B83EE93CFE |
| 21 | 21 | 0 | 0x1D702FE4A54DB0D04CB5544709062C3B1B9A |
| 22 | 22 | 0 | 0x1138EB1890A2F937C44976A1143C045687DA |
| 23 | 23 | 0 | 0x64B6A4BCB858AA2000BEE1670671DE372AD0 |
| 24 | 24 | 0 | 0x4BD9245280AA3DCCBDE04FCECD0D2F7F239C |
| 25 | 25 | 0 | 0x3B5BE1F4D4217A63774C59A33DC120A3340A |
| 26 | 26 | 0 | 0x1BE2B98347E2034F48A552742029079B5CE0 |
| 27 | 27 | 0 | 0x028D1838CF58DE02EFA96565B4C88D8B67BA |
| 28 | 28 | 0 | 0x5F68B1B2A7B73CC1F2ACEBF5B0AC1BC400CC |
| 29 | 29 | 0 | 0x665C532EAE0EFDEFCD6802FC3A7310EA5348 |
| 30 | 30 | 0 | 0x107D32AC3D373195BA843EBE6968C4BF9BE2 |
| 31 | 31 | 0 | 0x3FEAB859E5262F941B654C60720DB330F334 |
| 32 | 0 | 1 | 0x1EED6EE8F4A3C06B60DF5B116089237C300E |
| 33 | 1 | 1 | 0x19822C4632EC86450C6FE10A51E5C0FD5F2C |
| 34 | 2 | 1 | 0x2DDE838B1D072B0CFBB04AA294991CC04696 |
| 35 | 3 | 1 | 0x1C357F566732B055A01C0139653483A7C81A |
| 36 | 4 | 1 | 0x03B5252046ED369F0B98CC6F9DF0C74D5B2E |
| 37 | 5 | 1 | 0x32D21CF781A89AB9891534683411128FD7AE |
| 38 | 6 | 1 | 0x30E0EBF1A21A99E492755A1A85B0B712A660 |
| 39 | 7 | 1 | 0x63855C3358BA6EC7E5C7C8ED5B43BFF9084A |
| 40 | 8 | 1 | 0x662AB8C7A8E37FA564F4FE6C2D23493FD8B0 |
| 41 | 9 | 1 | 0x5E9F2165C7ED09BE6B35FA315DE9BC719518 |
| 42 | 10 | 1 | 0x458D1A911535B85F1B0E5DBA01F6910C80E6 |
| 43 | 11 | 1 | 0x491E3B003C66376EB823538EA540F6525814 |
| 44 | 12 | 1 | 0x79B4D5E3A846DB6BF3BE70EE0B2A748FC442 |
| 45 | 13 | 1 | 0x7E6B673849A5284811CEDBE051E2B7447D5C |
| 46 | 14 | 1 | 0x5F6022FB7C7C75B2F44F414E715A98B34A9E |
| 47 | 15 | 1 | 0x69A2AC9A97DC0F394ACC4F127B3C521FBF62 |
| 48 | 16 | 1 | 0x0D4EE6A642CCD0924F0BFE83B6DD7C3BEC70 |
| 49 | 17 | 1 | 0x0EA5F06FE05E70ACE66571F7FD90435E698A |
| 50 | 18 | 1 | 0x2020682A263C1DDC29E2C4BED90946B9646E |
| 51 | 19 | 1 | 0x0547A6A4F4DD8D0A5025DC6D726209BAA618 |
| 52 | 20 | 1 | 0x50B482EDE4B8A9D9D75163EDED1CC62458A6 |
| 53 | 21 | 1 | 0x2422623BCF0619F22DA083E114A5EC9517AA |
| 54 | 22 | 1 | 0x0F35DE05FB486550A17D7FC4E468EA8E4E52 |
| 55 | 23 | 1 | 0x429894A78B0FA1CC14C8D0FB436CD57FFB84 |
| 56 | 24 | 1 | 0x0F80B04278E8484316B16B6F4E8B5C444DD6 |
| 57 | 25 | 1 | 0x4F0018149EE6A47C4C35851716D04BB770CA |
| 58 | 26 | 1 | 0x20E2DB0462772C48347CA565714C2BC413F0 |
| 59 | 27 | 1 | 0x634CEF7A72CC1DEFA56D9F8C95D36806AE0E |
| 60 | 28 | 1 | 0x45DF81B8828935A7C6971FE3A97A599CEBF6 |
| 61 | 29 | 1 | 0x7BE67E4C06E4C7B738B0AEF1E84356A9A456 |
| 62 | 30 | 1 | 0x6F9CDC4866B608E80F0817ABD1626D296A20 |
| 63 | 31 | 1 | 0x5DD3AF691E70FF5639763F9AC036182CCFE8 |
| 64 | 0 | 2 | 0x4CF8379D3B7C64525122A257BD3485F498C6 |
| 65 | 1 | 2 | 0x546FF1E0695D08CB4DDF965845492E33A40E |
| 66 | 2 | 2 | 0x6E2C2032E63B500EA3B1AD51A664360DA5CA |
| 67 | 3 | 2 | 0x1A3E0B25A53D9A54ECB67F70B7E77405CE3C |
| 68 | 4 | 2 | 0x4033DD1490A4F16870FEC5CE550B0A65E99E |
| 69 | 5 | 2 | 0x71CF2239AFC076A0226444C175E70B4128B4 |
| 70 | 6 | 2 | 0x00FA9A986CE47DB2D5283AF64CC70CC1285C |
| 71 | 7 | 2 | 0x73CC56FE96E5DC0690CBC367375F04995BAE |
| 72 | 8 | 2 | 0x4D08929C05DEB983A35560816E4BAB23B98E |
| 73 | 9 | 2 | 0x23764A50366D33CAA31C188F283EEF697DB8 |
| 74 | 10 | 2 | 0x5EE35010AC4ACB6DEDD0E887F9322F0C39D8 |
| 75 | 11 | 2 | 0x6171A046B512839766EC9670F74DB298AFA8 |
| 76 | 12 | 2 | 0x584B3703769C4B78001861C91757B191A2BC |
| 77 | 13 | 2 | 0x7C5B3E3F31D6B30FA1973C5D40053D88AD72 |
| 78 | 14 | 2 | 0x308CB4842EA2650B93DF2F259B103873BF06 |
| 79 | 15 | 2 | 0x5B2A19992C807971A5AC58BD1C63780F7FF6 |
| 80 | 16 | 2 | 0x450EE0B668F2C0322109D6782D23EF6548DC |
| 81 | 17 | 2 | 0x53F4D7C502823850AD0768E4699072DB3B20 |
| 82 | 18 | 2 | 0x6AC083142D01D27A73412EC49F7C560E671A |
| 83 | 19 | 2 | 0x16BA9E844F2C64923D85AB9E133D72CDD010 |
| 84 | 20 | 2 | 0x785286976B2768A26855704BF4731BC049DC |
| 85 | 21 | 2 | 0x2A317C996909B5C6F89F93611AF2228638BC |
| 86 | 22 | 2 | 0x384A3CC0FA28866F5F195EDFB3237530B496 |
| 87 | 23 | 2 | 0x5801186BD928C1A2E0B4AA6C65F98717F82A |
| 88 | 24 | 2 | 0x044E18CCA7AF3F2FB50DF25F6B40B1776CAA |
| 89 | 25 | 2 | 0x3C3F9CC61AFE90B1D7AEF8DDD925D413251A |
| 90 | 26 | 2 | 0x0D70AA48F655A98B08DBBF4F77A5D7901F76 |
| 91 | 27 | 2 | 0x5419A8C1924A7C0613F98EE97C3975285036 |
| 92 | 28 | 2 | 0x7D81685FEAC6EBAA5D786C3CB188C4193B22 |
| 93 | 29 | 2 | 0x3CE08517717CAD65B042F33130BA312E02D4 |
| 94 | 30 | 2 | 0x15024AD06B0A07D035D3E999B9D90826738C |
| 95 | 31 | 2 | 0x532FDDF76524FDA34B68363D237A3D711CC0 |
| 96 | 0 | 0 | 0x04C3904B2AAE4B72390AD3C7897B63768226 |
| 97 | 1 | 1 | 0x06BCDF3326F1A4047AA7AD255221D6C20380 |
| 98 | 2 | 2 | 0x15ADD035357C1E8A61BD4F3B7598B9C18082 |
| 99 | 3 | 0 | 0x0588AD5EE583EA824A4B2C4CEE38D9671FF8 |
| 100 | 4 | 1 | 0x1ED5FAB7C07990C6013F321573511C3CAF2C |
| 101 | 5 | 2 | 0x652F573841E61C07B6F939543FFD1BAA2364 |
| 102 | 6 | 0 | 0x3D36EFBD347A29CADD8E01A8D9C27857EF00 |
| 103 | 7 | 1 | 0x2F6667F0EDF7E315905C53EC679ED1608EBC |
| 104 | 8 | 2 | 0x5CB8F719B12545FCDBA0C8F61A12B3E943BA |
| 105 | 9 | 0 | 0x58D2EE908B41EC3E46B071D3F7A455C8C220 |
| 106 | 10 | 1 | 0x7428CACE5AD1072E90307973A87D8A20A260 |
| 107 | 11 | 2 | 0x429225DD0707FCFE2036961F7776A75DC5CE |
| 108 | 12 | 0 | 0x413FFFCF6BA9A2B255B2E5299386AC66F02E |
| 109 | 13 | 1 | 0x3FB212E044A58A5EA791668BCE6A62EBF470 |
| 110 | 14 | 2 | 0x05265C8334CA703B3C7466B7A928A84FCEEC |
| 111 | 15 | 0 | 0x762E49C1325E100F76B2F370D2607BC55C04 |
| 112 | 16 | 1 | 0x21B4EBFB8F3F87DACE14D3E52366AC8CE6C4 |
| 113 | 17 | 2 | 0x24E5A63AA02815CD025E45E1D1FBE523B346 |

The following are the preamble modulation series PNᵢ, i=0, 1, . . . , 113 specified in Tables 309, 309a and 309b of 8.4.6.1.1 in IEEE 802.16-2005, which are incorporated herein by reference.

TABLE 309
Preamble modulation series per segment and IDcell for the 2k (2048) FFT mode

| Index | IDcell | Segment | Series to modulate (Wₖ) |
|---|---|---|---|
| 0 | 0 | 0 | 0xC12B7F736CFFB14B6ABF4EB50A60B7A3B4163EA3360F697 |
| | | | C45075997ACE17BB1512C7C0CEBB34B389D8784553C0FC60B |
| | | | DE4F166CF7B04856442D97539FB915D80820CEDD858483 |
| 1 | 1 | 0 | 0xA9F7AC1BD0A4BD694D3EDC2991CC3B2D24BF26A22346F |
| | | | 8DB370202CDA25D382D4119AAC676E320A938A95762C40786 |
| | | | 89B6024E477F0EDA8F563106F0D70EBE3E006F75B50B537D |
| 2 | 2 | 0 | 0x56531FBB87033E4F362273BAF0F8879B45B9F19143E5494F7 |
| | | | B025D138DF057756DE625196292AF6D28FD0AA08453E5B9871 |
| | | | EDAE3E680B848C67BFBD7ADE73CFBBBA4E81191267A |
| 3 | 3 | 0 | 0xB397F552DEB2717CC19DDF0D59674DD6F6D3866A3FD023 |
| | | | A009F592B56460660F1D585E3078AFE272D97FDF4280790C3A |
| | | | 9E5FCF9910895E9DAF2BF65728F7390C930428B4E6793C |
| 4 | 4 | 0 | 0x1BD4C84B42DF6B7DC53F6C7B8E223A3B16D8E214CFA546 |
| | | | 9A8D22246BCF297E5F92159406608B8A0BB55EF64A85B1241C |
| | | | 5CDFA048CF0492AB3BCF46A8E8FE986F06E246F1E06C68 |
| 5 | 5 | 0 | 0x4E00947B6722B09389EFB4F6951C488B368393E82549483592 |
| | | | 87441709C6F0E4463C067733C42A7FA89645D7D69AF2ACE540 |
| | | | 2AC473DBF2C75ECB8B630BAF4B27F282249BD52660 |
| 6 | 6 | 0 | 0x494CAB6935E10DB5D6E985997849EA45F0D5E2EDF7670BF |
| | | | D9643531760D9F7CC01DD63BEEDFECB7E806F3F189291C074 |
| | | | C8289D93A95324D131391E23EB9CEEAB0E789DA1F5B9CB |
| 7 | 7 | 0 | 0x4C5F10264D6C5085346E86BF8567294523C1B683D2A220D9 |
| | | | BEDCEBBA110620BB53ECB0338BE7109240E22EC902FCA05F |
| | | | 97338BB9DF2DDEAF7C795BCB160BD4F01A6DBF2A729373 |
| 8 | 8 | 0 | 0x79797D9AB260C20D5A460CDC49B2D0285E095E835EAF2E |
| | | | CC74E010DD8A53797CE0EC2EEBA51E779AA6B749B8E69FF |
| | | | DD632AC79D64143467E73017113BCDF45E787D0A9EAC3D22E |
| 9 | 9 | 0 | 0xA1B9AC2C3D5B9BAAE5067C9E4A83C167076BE7D8699AC |
| | | | A710FF205DE774FD46DD5F7851A2149D61E57152B98B6AF41 |
| | | | 94B6FED90ADA008D1D5F8DD87E8060F943BC9124C1999236 |
| 10 | 10 | 0 | 0x066E5FA91D00D63B26036009F8C69142B9D936396FF9E1378 |
| | | | 6478BBFF5DE6F184A0F844663950F69AFEDEA93CA4A3BF94 |
| | | | B13175A2CBBA3836A34E5CE6D763767B35515F332D836 |
| 11 | 11 | 0 | 0xF443E9FBF763DA2A5137A57C7DA504D194EC1797AD33365 |
| | | | BAC2F0C94541F4D47A664A7A17308C37E06BB0826FF999C15 |
| | | | EE430A3CC54159E3B7EEBD5FF307BB24A939AB261E2B3C |
| 12 | 12 | 0 | 0xF38BE6D2108483C056088C5E7C8BF92E9C973E0B2ADA934 |
| | | | 2B46C06C4C2516CF7B9E6043E2947AD40F41734E02A9ADCE9 |
| | | | C70E03C4D50E7EAC73DAD56BDBB796289DDCC357776DE2 |
| 13 | 13 | 0 | 0x104AA84E70B163A42654A45995182B1C3DD63F4BCB09ECA |
| | | | 79A0D6D2D2A784DD6015794598310BE087F75019227F899744 |
| | | | B7C73A9008C83C0923D5DC154FB2DCBF8983E709BCDF3 |
| 14 | 14 | 0 | 0x0B49A507AC4EAAC7551FC4B00658A28D951FC81723CC1C0 |
| | | | 24AAC6A9DE9686383C28036C762C020012D797866DE589B36 |
| | | | BB95DFDAC2B3D0AB9DDE0B9719918062FE824E063BA3EC |
| 15 | 15 | 0 | 0x64C14C7D3725A74923E6B2FB1C3BDC77FEE58CB0AF310E |
| | | | C37F22C93E2C809AE8410963E6CF5E7E192502960F0272244A3 |
| | | | 1D2CDDC657BCFF422E29C50D5E82EDCB44579181BBA4D |
| 16 | 16 | 0 | 0x210D8A8E602BD53F981BE763E10F4730BDA53D2F89BD1D9 |
| | | | 1C8F2DD5B96732935F789F643911937344E9F2ECF3222AB076 |
| | | | BC2B5EE407DC581F0EF9FFBD56D14D137A0418ADA06D0 |
| 17 | 17 | 0 | 0x88960A88E3F79C95D525DB49679C20A736D0E9E4D1FCB9D |
| | | | E7735AE1E947F4E93637E98143D6BB779394C58F2AC5A9BD7 |
| | | | B2074E98F1B2026B67B507CAAD8076082B09FB345DA02D |
| 18 | 18 | 0 | 0x1D2D5C8CDEAFCA5EC180D9638CD0F277AF08AB5133E6D |
| | | | 60C919AADAD00569E5F902D40500542631FB729FC3AF456C9 |
| | | | A47E3EB967D51E09D712D8D49A028E738BEC90061B089C9F |
| 19 | 19 | 0 | 0xA063E03DE6C137F3FC56F970052BCF7333C8451BF5D18D1 |
| | | | B9AA5342E79C25451C1D862ECB5CFF21B7CC203817D78C192 |
| | | | EE1A68976652E1740C4B123552C85CEE524A2AA90D428B |
| 20 | 20 | 0 | 0xD2A7F126A9599093A9262E66A2471B6B6A2ACB0A4330A11 |
| | | | 4011366CBC3B01CC85CF1915982BE64DDDF8EEA0985D8F47 |
| | | | BC4B41381C58271C30578960EEFB054F299C721B81D5DFE |
| 21 | 21 | 0 | 0x7682842351C76BC8E4A7EA4EDDB0F92F6E876FCFDFDAA4 |
| | | | 987B38FC4FA47C52EF0070DCC8C77FA622B20BEBC23730116 |
| | | | 60B4960EF49FB5E519D79E12029C7D13C553EDC48564A52 |
| 22 | 22 | 0 | 0xAD6143F875C4C965A7018B8230D8D50297DA2C54A6DD52E |
| | | | A6207620F4A66EAFEBC4DD56233FF5DF78FB20CD74ECC6D0 |
| | | | 1232FCFB9CBD36B3381F0224EF5DE7BE0AFEF0A1AEF3D82 |
| 23 | 23 | 0 | 0x9A14B722E05D8455A80B4A1B1D12A30C1E25D9488BAD48 |
| | | | 6C639CC7BDF651E957E041A7C092A916BF3E3642121350579B |
| | | | 3F8F8F4A30570237E722A6DC532A26F4FD4A0767D91A8B |
| 24 | 24 | 0 | 0xE6944DEEE85D75E3C5D9B90912177D8A85909D87AC21FA4 |
| | | | A51660E11D30DBEED391E5972D000EF4E9BF30B63B18C0285 |
| | | | FE4151A4231C289A824D405142B7C775C3C68D8AA1D8A7 |
| 25 | 25 | 0 | 0x9927326FDFEC99025AA1B79364F06C63AFE4A96C2A20FF8 |
| | | | B151EF97AFD08E161EA6B10A1FA74794521DE02645C2561D3 |
| | | | BEA5D382AE3707112619403E23C724B36B791DFAFEAA3A |
| 26 | 26 | 0 | 0x03C19F38117AE5BDADF256FB4A223A660E2D626598F56580 |
| | | | E30FA2E40A521FE5D68709B7F62E4C08CB9A26AE12002AD2F |
| | | | A9DE6C2B298538556EFBA71626A02745C3DB5EBADD3F3 |
| 27 | 27 | 0 | 0xCBA035B40EB7C8A3A048C490E38935CBF956C58AFC891A |
| | | | 6C112C0321CF5262498915794DCA703BD31A96FF4C0636F2D5 |
| | | | E9F17C23F1486B90715597D565017CB8E424DE9A8E464E |
| 28 | 28 | 0 | 0x9321B7BE085143649644BCDF8342FCAD3462DA1C572227B0 |
| | | | 39BBC6F58B52EEED2ACFB38F9CAA2BA2F513A87B10DD19D |
| | | | EFB6A9972EE12D81C83DBFB3CFCC93D35ED252D0E1A3D1E |
| 29 | 29 | 0 | 0x215F6EA7C7F95C74828485AABF6A5F54FD32D1A8F4F6F1C |
| | | | 20E6CDB57FA81ED70DFE44ACCD4B37D4F01AD3BF31AFBB |
| | | | 38A4DDBC613C8809E46C1247222E5041D8CDC08F37F679878 |
| 30 | 30 | 0 | 0xB5ABE9FC329600031F97DEA8CF5B17EC432BB9F19082A3C |
| | | | FA2682AAF121EE855873119A78869AF988BD90C64A7F312247 |
| | | | 27D22F74D7499AF6CD3B649C54AED6DC84DD8AB876B84 |
| 31 | 31 | 0 | 0x956D097E914338D226020B8A3BA5B3BB8733A9723CF19485 |
| | | | DD9D22670B1328B825A6BA154586EDE60EB328AF8DF114182 |
| | | | EDAEE401620A1E870BFFFF430922893C1F54A87A90BD3 |
| 32 | 0 | 1 | 0x251D994101EDA04D8BD0B8EA6FA20AE590C2CC199AB083 |
| | | | C6AE61F091F2DD41D989EC164B1481D611BE9CEA0094AFE9 |
| | | | DB56A4763F55B26E54EAB73ACD7D4BBA64C1421BC3EB9D67 |
| 33 | 1 | 1 | 0x113A5FB9C529AADC9CAB1FB882905601778659CDB69AFC |
| | | | BADDF8B42314A7985B5F87C20692309D350454FF9326481683 |
| | | | FADAE4711DD0CC5DACEDF7CD5DF1177D60EBA4DBE657F1 |
| 34 | 2 | 1 | 0x9F08189EFC6B5DE6C2CFDCD13195DE077586B8EE01E00B6 |
| | | | 468B10A53FAAC1DD846E2A01681980D444B6AD0D34C34EC9 |
| | | | CFD9341507878EC9FBAE498F5A20614BDF3E4B22DD285E6 |
| 35 | 3 | 1 | 0x3ECD476669A04A260414FD16F3F525AA060F20ADD9334A2 |
| | | | 9A9D9F90618916EF51840C8F53AB596297F0782BEF426E8B853 |
| | | | 9C9FDE970455B58F533FDAC1711DE6310E7596ED285E |
| 36 | 4 | 1 | 0x3D6BD09A3DBD9ECCC1C584E71C87221CD266087C7A692D |
| | | | 3EFF2D5F84DF2011EA3675853A61CD75D23600F8C115E03406 |
| | | | AF914938170256B86DA5646CE0211FFDCD76A9A5E8D840 |
| 37 | 5 | 1 | 0x27F0DA91D4AD1F39F0EAD459E2705CB2CA029A8E57592F1 |
| | | | 697877199FF707D0411D6068A0664594D89568460F268A225BB |
| | | | 2AC0ED043659D779EA84656DEC0322F8C0CB111AD2C8 |
| 38 | 6 | 1 | 0x616FBCE479AAAC98B483FCF6EC06BBA84580EA98FA517B |
| | | | 3065A418CAF2C965B7AF2E7866B257390517016F25214900881 |
| | | | 93372879FAA8954651E7B3C80BA1725CB781726F32328 |
| 39 | 7 | 1 | 0x357714863C5F477BE963806EA9D6EF6350BAFC1C183FCC6 |
| | | | BB47FFFEAA9FFD86358918F6A218266D624CA07092EC24466 |
| | | | C7F7120C1887A3F59A48EBAB67F24A6E8930B862F509A3 |
| 40 | 8 | 1 | 0xABE49D0F8B9C8406BD70B3FD83758768CDBA98164B929A |
| | | | 1EA18D59BD44B80F9BBEF9D1CE51E4EE1CF21F6CCF18A7D |
| | | | 4A92C26C121A22FC95663F0B55B892CF7D3D65812A503DA48 |
| 41 | 9 | 1 | 0x6898A2FC8C36DF0B84380FBCDE70812390B644E3B5BEA87 |
| | | | D76C9123477638B331BEBC075664EA58C15680263664C48BF3 |
| | | | 411C3C13789C504A01FB4C7B9AC86AA524075E52C6A90 |
| 42 | 10 | 1 | 0xE7709988D2D2D6ABC6CEFB025FFCAFCA4C0E75C883529E |
| | | | A439B75229ECE88FB5BD5D3BCA17C25BEB6575D932D01B5 |
| | | | A63E044102E208C071C734EBA55712E122822ED2F2B379A11 |
| 43 | 11 | 1 | 0xE49DCC8627542BA30FA500DCC23EEBF5A54B490EE7632C |
| | | | 6BE57C724C3E74CD199930AB1D929D425185E2E1220CD2300 |
| | | | F487392F4DC29416D332F13F8E760571D99617B263F387D |
| 44 | 12 | 1 | 0xEE4CBD9B0EC65DE6DA78A2A205E5908B74127BDE612A9 |
| | | | BD2D8F0C6A2B9E675401A9DDAA30FF9A55E87DAFFA3A33E |
| | | | 53AAA1D96A60B326D7F6FA147098DD825BD0FB13ADDFE01 |
| | | | 569 |
| 45 | 13 | 1 | 0xAD7DAD0BCA42DEDAFCCF7E57DC58D00E691E81C04B98 |
| | | | B2EDB66C66570B204B8352A08744D8A603C2A7769C7A9EE93 |
| | | | 8189A45737B86871E5C4025EE594D827C603E3A49FD45519F |
| 46 | 14 | 1 | 0xF8F29BA0D2FA2D529EAF2CE9383E614F5AE8CA06658DD0 |
| | | | 39AB2C9912DFC7CD1BA9744339E537850B7E4EA564819772D |
| | | | 3320B1C7BA73EC24D90B8DCE17EA5DAD53771F68B050F43 |
| 47 | 15 | 1 | 0x9CC0ECC9E7E8940DFED1332AF492CFD39A21F2820394EF0 |
| | | | 523019EE5290A2B4281FF032C238A6BE41116C274E918F34F3A |
| | | | 27B5F147E10D41658CDC7EFEDC3135255C2B83B0AE6A |
| 48 | 16 | 1 | 0xFCE9C41A74CBB56634447836109869E557C5A0FAA1D4566 |
| | | | E36A51258CE6D096FBD3E0B7193418D9DFCBD27693F8A5072 |
| | | | 425D4E3F33DB5AB45B1EF3E11A6730BED42961DF0354CD |
| 49 | 17 | 1 | 0x7941B66A275FB8F0BAA8EF7FFCC36AAA660113B66BE476 |
| | | | D629AE512E489341F6C9F84EC1BE1C05CA3C850D20B1A12A |
| | | | A9C94E1A6541C29A9B4BCD41B94460DEF2E9643ADCE86728 |
| 50 | 18 | 1 | 0x0A91F390213C9B2ED372BA19FC42EE85AAB2598B58D2F71 |
| | | | 84EA920546D6A81ED316551B74B341E238A7FB83A4EF7D9EB |
| | | | 0939B7771A6F4D0AF1F72752FE3234793D3CDC19BDFE08 |
| 51 | 19 | 1 | 0x96949ACCD785385AE8DE99CE42BBB73B996A886115A78D |
| | | | 0606AEC14D2E46E849BF88F9A2E17C2494704F1020CEF85FFD |
| | | | E16B7483DBC6A130488E3AC586E528A00B90134776E08C |
| 52 | 20 | 1 | 0x53FFBA26676A4FD1A6C30B8E4EA02DF535C922978CD24F6 |
| | | | 099C25003567F207CC5851656C5FD0D3F071942A16F1DB48DF |
| | | | BC26BACC15A1E618FF35F3DC3E141E3666BCA507ED72E |
| 53 | 21 | 1 | 0x7F3219ABE1389DBED8FC2F1C9C0FCE1974E71C224E1922F |
| | | | 4CAD42E40AF15A5ECDB14221480F964E67BBD345C44DCA08 |
| | | | 53548B399E3DF4D054D176C0804D1B1154152BE973A8896 |
| 54 | 22 | 1 | 0x8D5552CCA9EA46C991FF81A35873F43C963E02ED24C4102 |
| | | | A79F5EB5EC25814511BA5DD2FE9FB9699E7ED76F965B24748 |
| | | | AE1A4A3A590F4F13E4722CCE399006F79AD8CE673178F7 |
| 55 | 23 | 1 | 0xDB74EFA478268CDDE2596ADF9410FD83FCEDBB07C6DEC |
| | | | 7A3422A6CC66EF901C1534EC2A83E1A89BA207C721ECF3D42 |
| | | | 918FF40B3863379FDF3CED7A9CC86E348CAB032F8FAAD9CD |
| 56 | 24 | 1 | 0x5811ADD9240A7B3AF35CACA6EFCCF4090A54EBF33DE54 |
| | | | C077192354DDEB81CC968D18354090B09D7472C83E1696E195 |
| | | | 45F08136EF20CD74656BCD31296066E03CC89E22E47CF47 |
| 57 | 25 | 1 | 0x871ECE60EDD2E19360D13862A15242250635774424B22465B |
| | | | 3EF625E72072B7C45D81076DB4A5BFD5BE146F15CAA80DA0 |
| | | | 31763DAC23BBBC54249E9878EC465F3EABE0B7AA497B8 |
| 58 | 26 | 1 | 0xD8259BAF89D3E13242CC1CDBA9C0281A09919D24ECF5BA |
| | | | 83CDCD81E698EAA37DFE3E5802B3395B80A3DE91CF6C4BE2 |
| | | | D34BBE985EE4041C4290D0A9185F115C963AD536E4133426 |
| 59 | 27 | 1 | 0x1203A1FD3F7B8E9D97A3812D4375D42BC9E8F0E393BD669 |
| | | | A8099407EC0356DC45FEF848C98F3EF32A9A850CC67CE43233 |
| | | | 9CBAF38BBA7DD0C94BC03B4704866509255E28450E459 |
| 60 | 28 | 1 | 0x6A78A3F0DC5E4FA504580C37F5416BCC4A2BD51FC1A7147 |
| | | | 1BD1433EC3DD924E7130A7B2B331AB0B4AF6CF94C045A9C2 |
| | | | 46965F46478D939795887EE3320BBC2D5DD5FFB06F894E8 |
| 61 | 29 | 1 | 0x3042F24E050BAB38880A07BDE5D28AEE4AD59E0D71AB59 |
| | | | 824122E80F8FF67BEA1ECC865F50B25CF5095C642B800E6A4 |
| | | | D132B49E5968DEBDDA029A227AF332CF034BB937B471603 |
| 62 | 30 | 1 | 0xC82853465FBB213A85A52888464E5D38D997F6C31966A94B |
| | | | 452A2DE853CE38010BF9EA930BBD318189D5D2D0BDB44652 |
| | | | 48A2E8B481021531BE01F5E0FF1BAB75370C57B36BE6E9 |
| 63 | 31 | 1 | 0x2B17EC947632DABA3A2E11022033F20F873032F51F0647111 |
| | | | 11D0C215E9E84C11A9E70950977527960700B37C6FECCA57C3 |
| | | | 5A91873C935D7EDC22CB44DCC251396173CAC82B912 |
| 64 | 0 | 2 | 0x83FC05D6DED982EB95B06E16C91EF94B441BBD4868C09E9 |
| | | | B3A251AD72427F2124607E151796070C2819E395EB68A2C5973 |
| | | | 91636333A7E492B70D8EA7397FFA1B28C20E0820CC45 |
| 65 | 1 | 2 | 0x45818FBAE49B983DB9B8FBEA1E816823430CE47BD159317 |
| | | | 3605CA255CCCCAE73C7283336BCBC94133DCA64D675BBA8 |
| | | | 48A3E1C2EEE35D6085F06E72EAA696FBED6EA545F27D3692 |
| 66 | 2 | 2 | 0xA005745E452ACE6BDDFC4A9F6253BF4B467C93ACFF0F663 |
| | | | A3F5949F15A1D266DEB0D26EC16D2A083F830E878A0300D74 |
| | | | CFA3266CBBF3F0244ED56344D6AD5D887B3179CE56890D |
| 67 | 3 | 2 | 0xE52F56367EA45E4683E020856D05D08391D3D84766CA2253 |
| | | | 1B3EC6BE682E76B6ED7BCAABC3AB6BDE32C4F700D4CDFF |
| | | | 26F79AE16499D2B70EC389AC3ED5E02FDF5C43B296CF965D |
| 68 | 4 | 2 | 0xC5C62E3A911A0F28BF6A67E1DA2486FED7110B08F0A934C |
| | | | 930AA035290D098857ECF3A069203A2560DADD5016802D9C1 |
| | | | 596526C7F1DA7C7B53360B0A673AA8634FB94D5838DC3E |
| 69 | 5 | 2 | 0xF9E176A9837BF970D5FD51732ECB8D90FBD12F62B62F938 |
| | | | BE07915BABB0C6596080C832CE7FF914C849B9DA66F2380F3 |
| | | | 058F66340A34CA43583EC8EDC1E5CB5A2A25436E72292D |
| 70 | 6 | 2 | 0x5C26DB2489BE5197B20CD6B38B181B7789DCB90881AAC4 |
| | | | B4317B2F40B44884144A1B15BCB53C8E30FEC419861C54B561 |
| | | | 58D9719E448B8A8F455F5B116275D796329059CDF682D3 |
| 71 | 7 | 2 | 0xEF35242D5C426C1EBD9563A761CFBF11A531ACB938922EB |
| | | | BA5227D8292585B777783972DA79C853A2A178601E6CFEA353 |
| | | | 80045B50EE628F13AE3EC5B72FED52F92F731BB594DE8 |
| 72 | 8 | 2 | 0x17FBB33193C68A1CAA8CEF5CB9A7FDFA1E89994F1779D2 |
| | | | D0DE69DE75A6B338A07635C80A58722BB01398252F6C46AB7 |
| | | | AEA79A6FC05F383F89ED65C49A2B9FB0D82A6EC03DD61F5 |
| 73 | 9 | 2 | 0x076C1A1DCA870DF36638307F891A52F737BA2B54EC0AD1F |
| | | | C5424D4F32DDE168ACE9B08653DEF8A23BF37CA3D306138D |
| | | | 698A133834BFB65BDE57048B9EEC630B13E91EDB1B52E8F |
| 74 | 10 | 2 | 0xA6800969ED0CE80A76F0F9BF7597ABE76DF60F243EE529C |
| | | | 63AF72BAD6AB8B3F0B09DFC132C2B006827E55E352E3940A3 |
| | | | BB8EE3526522ADF65AB76492BA41A393740A4B85CD5113 |
| 75 | 11 | 2 | 0x64817485E539E02AAB074982A56DC6E867C606313194BD66 |
| | | | B4CF8B9E92C4F9FD138B0E6EF36F699A3E6DCC46741B8CB1 |
| | | | 6389EBA2C745398A30EA3102B6BA4FE9A8DA9605F929FF |
| 76 | 12 | 2 | 0xA3E438CB9EC48C4F4DD92C24950D0F1EAE7EEE920501C2 |
| | | | C82531EDF8AEE3531F8D6B82D28C1FE0731088489FD215D192 |
| | | | 02DAEE0A57E3E1634C7A1BD5395CA64C64C14E5C02D436 |
| 77 | 13 | 2 | 0x8F9339B406037D35ADB9858576A62AF6139FD2B02D381C7 |
| | | | DF147A274E145F76DE5687AEC5BD3A715E0E893EEB6F24573 |
| | | | D4017B24B30D4357E339B104601FC2DD184DC9A8F0D76A |
| 78 | 14 | 2 | 0xDA85062511E22DEDB53797BDBEC8B0281818E890D438CB5 |
| | | | A48B2E4011FD5EFB2192C0FEDEE598372C7C06BEF25F9B970 |
| | | | 2A8A9F0F52B197E9C910BB63F467E53BF46A45F75C22F6 |
| 79 | 15 | 2 | 0x914DE1436839A8E2FDD4EACCD645C3D29E522E19E0055A2 |
| | | | 510679A977772830824C7363461CBF5D662456DB798BA72AEB |
| | | | 67FEB2FC28DAAD3FAE0048727CF6E9B237A82489790D6 |
| 80 | 16 | 2 | 0xA21E09CF0A98EB012E8914A31BE5BE53F47AF5650B6BCE2 |
| | | | 812F65C994A100EA41F732830EB3F6C6F7028BC9FB3C5D108F |
| | | | 63315DEDE8EE82CF5DE892032688E1C367D8567A20ACA |
| 81 | 17 | 2 | 0x6E11F29AE45A99D74D911777D1DE60495C2DAF1705C7844 |
| | | | FB7FC0A01247F3265F45D90A198ADCD0DB98A3CE22ACF24A |
| | | | 77C737E5BF99DCD7EFA6B6096B70C572996B62E7814236B |
| 82 | 18 | 2 | 0xE9F8FC17F5361DBCDD8F18F28CA90B618DF6B56D3481C9 |
| | | | E3B7FDBEA6D55FAB32A4310A52AD7AAA26D082B38D4D8A |
| | | | 2FCB70A3C6A4167515CA710E8F9B237F64B4D9A8C3CE8DF0 |
| | | | 85 |
| 83 | 19 | 2 | 0x11FDC3B4712101D717D0EDD7556EAE0940AA1683D4CA4C |
| | | | 22A7959436ECCA5E08A4BF2BF9EEF4BCE5E3E48DD77EB418 |
| | | | F6B84BF8937CE0CF9DAD247A64E9E850373FEE3D673F47C2 |
| 84 | 20 | 2 | 0xE8784553C091233730B7DA704B8A02BEBE45E5DEF4361394 |
| | | | E3B0E417FE3B571E641ADF2603402B8084A2D1318AF30CD95 |
| | | | AD014D553408393AD345C05D62F435C708948233EF55B |
| 85 | 21 | 2 | 0xCDD6E932F9D2FAD131E7AE666B758CC4BB60C60230FE14 |
| | | | 494D0F77E89A9BE726FAF8F9465AD0262D75C0A5374165A4F |
| | | | D2B4C602C0FF123F416360C112F6F95BD6790F81ACD858A |
| 86 | 22 | 2 | 0xA2702DE422E1CBADAA8285C1C3B1F41D44561BCBF10546 |
| | | | 6DF8070E604C733DE579755BCB8237C8DDB55A865B213D192 |
| | | | 9EDC553CE9B55994985F9EBEDF2A9F524301E3DA0498817 |
| 87 | 23 | 2 | 0x54487F7BDCDF87B1AA252798D7E5AD97E6F5263B7986B1E |
| | | | 3E637852EDC83FA360676C04E35A1F5045B0A0B7DE9269F8A |
| | | | 0E17F100D9AC78D873AE59BA0BA3E8AB3DDF928AD58F9E |
| 88 | 24 | 2 | 0x3461AA27EDE0A9F7955B469C41AE1485EFBFE4EB233B0B |
| | | | BEB5F31BB36AC1E72CA6BF06B1E58F8612096CFA7289DEA8 |
| | | | 927B6368DC845DC8476074B83F3C1545A17F73EFE214A3C9 |
| 89 | 25 | 2 | 0x2DDBBF4F82EB33001E46F08D17DB89DCE3C7CC127F6B7D |
| | | | 17839FE17A86F69178A1903E91857147348B491631336CB5D71 |
| | | | 0382B59FF71416FEC2BAF0A0584F2155EEB71C54F84C4 |
| 90 | 26 | 2 | 0x762E2454401F66455358322AC0CFDF76EB18EFA9684A10F0 |
| | | | F527537A54E75FAD77BD89E0D47980793C7B79B922C17792C |
| | | | C84BBEA81F6637192B74407A5B859EA1C873ED29D48FD |
| 91 | 27 | 2 | 0xF74BBB6C4B97071EBC19F3FE7840A67A3959BD9936335A4 |
| | | | F8BD10C9CFD925D8388C31B947BFD318FFC8B0967C132A602 |
| | | | BC31B29835AE070006A50554CF3C5F85D56832ABA9CA5B |
| 92 | 28 | 2 | 0x06493F32F3CA54692CAE2579388B97D99B5D540DE71F8B24 |
| | | | 05944C3A4FF18D7D45D4026DB9A867B85870BE6E23C9A8F84 |
| | | | 332D29B84B0303BB5179DFD89B56A14A37ABE053A0277 |
| 93 | 29 | 2 | 0xC88A3A3C0211A21661FD2B30937F0A187B6601E366A8FC5 |
| | | | BCD4210E2D5D3365B22D4D63273F822D89EC1745304FBA4D0 |
| | | | A9295AA51212C11C9D0A31FABB066289D8227B5BFDE8A0 |
| 94 | 30 | 2 | 0xA81E35C6A92953C584FE5FB3B6F1B0A532E91A49DB703D6 |
| | | | E20D796F4532630C1D64DCEA580188BDDAB37722AD5DDCC |
| | | | 9DFE7CFEDE1518D8E2ACA842F3570C7F381EAB9C5E4D485C |
| 95 | 31 | 2 | 0x08C0CC1C53E52AA366AFA63A48EBE2F7389C8A33CEB201 |
| | | | 73432B4828D68A547D4673E27F942FCA95942029CFE9F413FD |
| | | | ABE1D0BCF95022C5B99C1B229D151E9D3CA0A122F1BEEF |
| 96 | 0 | 0 | 0x9774EF2FA326AB19DE599803EB48740C90995A4508064B6B |
| | | | 19E58304229C5EDC578EF2C7030D4D2A01C9FB7618E7CB856 |
| | | | 4816354DD61EE144D7C94AFE8AB966875131B9F7C18BB |
| 97 | 1 | 1 | 0xB9FBD947B7F9F3C8F6D3799E095BE558E6A2D0550C0DD0 |
| | | | DDC92CC7BB53C1FE80D536B1FAE89C9224E3504629DBF0C5 |
| | | | 457944A72769B7162FBB0BBE18189749D3E7E264CFBA7A0E |
| 98 | 2 | 2 | 0xFD0E15EC140B2E87817AECC16F134B66221C759CCF0E5000 |
| | | | CDC0A3BADBB354D6845D745C22B1FB78C4205ABCF689495 |
| | | | DE555CFFB4E4164A9ED06E484A192308A8CA89048A92C32 |
| 99 | 3 | 0 | 0x28237E963DE488B97083F5A76BF5A861773DB61108461A8C |
| | | | B8FAE918887897033207CEBFB83380BCC45748732F9752C86D |
| | | | EA5F5EE4BA741C6DAB59375DDCBDC6EFEDBCD10DF3C2 |
| 100 | 4 | 1 | 0x023B7D4F9CA92D1E796C749B7664CCC4E8558C5CF20BF70 |
| | | | 2E39BC3AE525A9FAA6581F4A22EF6829A44156DAE4CABEA9 |
| | | | C6A41D5A4325C02980C8FA4621A7FD08D874C687B68C706 |
| 101 | 5 | 2 | 0xB7FF5E696A6923C504E2A64A097EB201EC52D7963D9D5DA |
| | | | 46051A4EBA8B2C2DB9FC4249ABF2D8CCC881F8AAD20230F |
| | | | 1B66D5D48CF2BCC5CADE7217E25FB9F6CB93CCE4111A33C6 |
| 102 | 6 | 0 | 0x6870AA97FE0FF504C4247EBFA8EF1A21B6EEE100E407F293 |
| | | | 086E1F48C7292BEC491DDAF0E2CF02455825089FCD985F77C |
| | | | DC4B561A6B8CD60CE31CBE6D467CFB4D153746FB7BE0D |
| 103 | 7 | 1 | 0x91466310F3C4F355233B54C0AB8CB818780691443781B71AB |
| | | | 6FB8F6CD516661E39075B4207E55400E081FD79C524628C8FE1 |
| | | | 277BE1A6165ACB5F154158D26593FED2C48EF66268 |
| 104 | 8 | 2 | 0x45F8EB9235B6DC375771B69789AFEEEBB806965E6931A844 |
| | | | F370CA14AA982635C54EA0BA973373D9FE010993B41EB8BF2 |
| | | | C219B09AD13B4FE7FDC7295C55858834490674637ED95 |
| 105 | 9 | 0 | 0x3AA7974B18884644F5C782A5E71AF70D91220EB0C468D079 |
| | | | AFB7DF8033D3AB54BC728657D60B349C575C8B3DEC403A6D |
| | | | 406E3FC4D016655D406B0B78389CEFCFF8A37D867A44DF |
| 106 | 10 | 1 | 0x1140B404D18CA769BDC1E1188BBB5BFA3B87668D158B087 |
| | | | 5F4D4EE90ED42974B5A02A6AAFC6977EACD194CB9E8423E2 |
| | | | 931F2CD9AEF6C90F44EC626C56518360D20AE97219FDE89 |
| 107 | 11 | 2 | 0x76BE5786CE3C33A20A3776587F83E6C5280BD4DF20FE6C52 |
| | | | D6BB582957E0CAEB988B32C3DB58027815D8618FB6FDB1BC |
| | | | F9E871D6C552AED5679BE98189D95708FE92750C5ADE33 |
| 108 | 12 | 0 | 0x33597C2D850E76B116A82F95C766D2002B9822D52E09B196 |
| | | | 8BEF3DFD48D9F53D5296F1559BEB0BC7791C1F6B666EE68C6 |
| | | | 05A2098A4A0BD57CE4F7A843068A8BA3BF0065ACA53C6 |
| 109 | 13 | 1 | 0x894B11E2BB6884D9FFD78C6A8103F3BD44E6DFE48CD0DC |
| | | | 89C63A4F8BA95858545D37EC1652AB2C073B99BC667D1F396 |
| | | | C87F9902FCB08686E563D0D30EBF3D65756A63F0037C240 |
| 110 | 14 | 2 | 0xDD08538B0939E852443E8801AB36C0FF50A6A0B63BBBE96 |
| | | | 9F6A5A60BD6EEF19D070C3A14366EC789D39D07CD8891491F |
| | | | DB3C7EF57A0A310C8A4DC0A03D5DB84DA0D6911C4CBA9B |
| 111 | 15 | 0 | 0x7FFA4EF380C6504225EA6C8339E130DB7E69577E9C46CA49 |
| | | | 4F66E2D5B25A256444606103A821615C2CDEA721D153669E50 |
| | | | 25CDC37904CFC16A84E3B745079E5F1F3E08B0684BBB |
| 112 | 16 | 1 | 0x8A608CAD1CD85FD846FB2A39FB61EBF9A219B9B7499179 |
| | | | C2C066F3F78F3B3EDEF15B7227C650BEFB63C950E1B52632D |
| | | | 78D1A0F34552BA138C877F09FCCFD30511E340F794D154A |
| 113 | 17 | 2 | 0x775CA156A4C0BDB8FE5FF3CFB91FC7BC9DEAF1B8B3362 |
| | | | D06C9738D332868BBA3B18A0A907EE7918D95510298E42F44 |
| | | | B7BFC39D9E002EE24D1806EE0436B92DEC06DA3FDA2230F6 |

TABLE 309a
Preamble modulation series per segment and IDcell for the 1k (1024) FFT mode

| Index | IDcell | Segment | Series to modulate (Wₖ) |
|---|---|---|---|
| 0 | 0 | 0 | 0xA6F294537B285E1844677D133E4D53CCB1F182DE00489E53 |
| | | | E6B6E77065C7EE7D0ADBEAF |
| 1 | 1 | 0 | 0x668321CBBE7F462E6C2A07E8BBDA2C7F7946D5F69E35AC |
| | | | 8ACF7D64AB4A33C467001F3B2 |
| 2 | 2 | 0 | 0x1C75D30B2DF72CEC9117A0BD8EAF8E0502461FC07456AC9 |
| | | | 06ADE03E9B5AB5E1D3F98C6E |
| 3 | 3 | 0 | 0x5F9A2E5CA7CC69A5227104FB1CC2262809F3B10D0542B9B |
| | | | DFDA4A73A7046096DF0E8D3D |
| 4 | 4 | 0 | 0x82F8A0AB918138D84BB86224F6C342D81BC8BFE791CA9EB |
| | | | 54096159D672E91C6E13032F |
| 5 | 5 | 0 | 0xEE27E59B84CCF15BB1565EF90D478CD2C49EE8A70DE368 |
| | | | EED7C9420B0C6FFAF9AF035FC |
| 6 | 6 | 0 | 0xC1DF5AE28D1CA6A8917BCDAF4E73BD93F931C44F93C3F1 |
| | | | 2F0132FB643EFD5885C8B2BCB |
| 7 | 7 | 0 | 0xFCA36CCCF7F3E0602696DF745A68DB948C57DFA9575BEA |
| | | | 1F05725C42155898F0A63A248 |
| 8 | 8 | 0 | 0x024B0718DE6474473A08C8B151AED124798F15D1FFCCD0D |
| | | | E574C5D2C52A42EEF858DBA5 |
| 9 | 9 | 0 | 0xD4EBFCC3F5A0332BEA5B309ACB04685B8D1BB4CB49F925 |
| | | | 1461B4ABA255897148F0FF238 |
| 10 | 10 | 0 | 0xEEA213F429EB926D1BDEC03ABB67D1DE47B4738F3E9298 |
| | | | 54F83D18B216095E6F546DADE |
| 11 | 11 | 0 | 0xC03036FA9F253045DF6C0889A8B83BAEFCF90EB993C2D79 |
| | | | BD911CA84075061AA43DA471 |
| 12 | 12 | 0 | 0x1E68EC22E5E2947FB0A29E4CC70597254B36C60331EACF77 |
| | | | 9FE752D3F55DC41ABFC7DC9 |
| 13 | 13 | 0 | 0x63A57E75A0434F035AAC4504B265081D497F10C77928B7179 |
| | | | 7C5D6C6824DC0F23BE34EE |
| 14 | 14 | 0 | 0xC57C4612816DE981C58FD6F8DE9DD41F2422ADBC522B0C |
| | | | E31F9A6D5F2A126DC08F69FB1 |
| 15 | 15 | 0 | 0x978256AF184E7ED17789B33D324C711B36BFBCCE5446EB0 |
| | | | 3687E9A0A839C7CE156104D2 |
| 16 | 16 | 0 | 0x011EC823157DD73150640CEB7DDB0A1F8F91E09599A851D |
| | | | 5C7CAF687CFB752D297D82FC |
| 17 | 17 | 0 | 0xC6DE82BEB7F57B9120E8A376D85C8F70FDC65BC660402D |
| | | | AC4AE6002EA2740C4F9E5973C |
| 18 | 18 | 0 | 0x4C74929D6F9FAB9E5BB761026038E076F6824295E0AF39780 |
| | | | 6ECEBC6DC713F03ACDC27C |
| 19 | 19 | 0 | 0x13E1E85C2234D0F3418001A35F135E10C6C918C36BC659FD |
| | | | A9D655D288A0BDAA8BF489D |
| 20 | 20 | 0 | 0xFD4AF2D8F4F08F1A7DF59291C9AEE788F641B8231CFB813 |
| | | | 376E0BEB68DFCFCBBE552445 |
| 21 | 21 | 0 | 0xEBBC77A493AA0C62C62F25EE5E8D0701F50386F49026FA3 |
| | | | 1487C9FD5C5206CE4EB00576 |
| 22 | 22 | 0 | 0x134F936F9E875842587ADCA92187F2FC6D62FFC3A833D8C |
| | | | DE465F9972ABAA83763AAEB7 |
| 23 | 23 | 0 | 0x3CD1DA70670BC73363D1B4A66D280FF6AA7636D07ECF32 |
| | | | BA26101E5EBA1594FB8A0420A |
| 24 | 24 | 0 | 0x918296B2937C2B6F73CF98F85A81B723D1C69DBDF3E01974 |
| | | | 9C582DA22E789562729D475 |
| 25 | 25 | 0 | 0xC323981B8B2240865F48D61AE1B3B61D88522B7358952F949 |
| | | | D4308CA15D1EE8FDFA683F |
| 26 | 26 | 0 | 0x7514A6FA5FBB250C5C8CE96F791D676036C344A44B242844 |
| | | | 77B44CB3E758F8BCD58F05B |
| 27 | 27 | 0 | 0x84C7FEC6E977FA1EC0C7CC9E0D067C73D8F846F82ABB345 |
| | | | 6D2104E1448D5A58D5975152 |
| 28 | 28 | 0 | 0x4841AFC277B86A0E067AF319422F501C87ACBFBDD66BFE |
| | | | A3644F879AE98BA8C5D605123 |
| 29 | 29 | 0 | 0xF35EA87318E459138A2CE69169AD5FD9F30B62DA04ED213 |
| | | | 20A9F59893F0D176752152FD |
| 30 | 30 | 0 | 0xA0C5F35C5971CD3DC55D7D2B9FD27AA17A198583F580EB |
| | | | 0800744EE5B6B3648DEA95840 |
| 31 | 31 | 0 | 0xA6D3D33AD9B56862DBF076E3ACE6A3150510CCC8BE77D |
| | | | E4E6E10EB5FE163765647D07DF |
| 32 | 0 | 1 | 0x52849D8F020EA6583032917F36E8B62DFD18AD4D77A7D2D |
| | | | 8EC2D4F20CC0C75B7D4DF708 |
| 33 | 1 | 1 | 0xCC53A152209DEC7E61A06195E3FA633076F7AE1BAFFE83C |
| | | | E565087C0507BA596E0BD990 |
| 34 | 2 | 1 | 0x17D98A7E32CCA9B142FE32DB37B2BF726E25AA7A557FFB |
| | | | 5C400B47A38B16CF18E1EDE63 |
| 35 | 3 | 1 | 0xA5BA8C7E2C795C9F84EBBD425992766BDE5549A7A9F7EF |
| | | | 7E44AFD941C6084568638FE84 |
| 36 | 4 | 1 | 0x33E57E78A5696255CA61AE36027036DA619E493A0A8F95D9 |
| | | | 915C6E61F3006CB9706BEBA |
| 37 | 5 | 1 | 0x09961E7309A9B7F3929C370C51910EBAB1B4F409FA976AE8 |
| | | | 679F354C84C4051F371F902 |
| 38 | 6 | 1 | 0x508A9EBAEF3C7E09CFCFC0B6F444A09B45A130EFC8C5B2 |
| | | | 2BCE87213854E7C9D329C9ADC |
| 39 | 7 | 1 | 0xAACEEF9BCDC82E4AD525185B07CBABCB74861D16F7C25 |
| | | | CFBA917B05463AD65391AF840D |
| 40 | 8 | 1 | 0x23060ACC5A125DAB207EEEE47B4EEE1E8466BD17DDA2E |
| | | | B3CD90D2AB7A758C213E6D7FE5 |
| 41 | 9 | 1 | 0xCA55521667BDA8B6F1B205201A51B3A0C05DE9EA06BC73 |
| | | | 268730A81A992777021F46055 |
| 42 | 10 | 1 | 0x05ADFCA2F8207DC6FF8D1A85A1DD4694D4C48A838C4F83 |
| | | | 3C532710021AC448A7B62B8DD |
| 43 | 11 | 1 | 0x218C951223D7B712DC98F8B5217388A830003C5F2A00F232 |
| | | | DD3475D2FC78C25B8D88FF9 |
| 44 | 12 | 1 | 0x79B94D24D721121EF678B7156F8D2666DE712BBF3837C85A |
| | | | 9518781903146A7B4D42A28 |
| 45 | 13 | 1 | 0x58AABEF6A6BDE4011CAC583C5104B2C6FC5A2980F856373 |
| | | | E5931A3C690245327581FA13 |
| 46 | 14 | 1 | 0x427D1AD18E338E16FCE6E23B4AD6D82A2144D53048F2665 |
| | | | AA94577AFABD26889FCB1F9F |
| 47 | 15 | 1 | 0x337FE0E4C15A22471AE0F6B6F91161A7DE2E1403D73587D5 |
| | | | C8355105D2F70642B2CE425 |
| 48 | 16 | 1 | 0xA3FCAA311B536AC9DB39FED9F4E996506B3181C58D6B7E |
| | | | 04157A3FD463F60468765BCFD |
| 49 | 17 | 1 | 0xF484FD1F57F53A4A749B86148E0B1D0653667CE1393198875 |
| | | | DDB0AE9179BBBDAAD53A11 |
| 50 | 18 | 1 | 0xA3E9ECF1E6048562BC89DB6168E708855F0D4AD29F859EF |
| | | | 36C9160DF407D85426233632 |
| 51 | 19 | 1 | 0x890519376D1FFAA2894EABCD6663B0A3C2411982C17B012 |
| | | | 70E0FB0B289D4BC8C3B83DA9 |
| 52 | 20 | 1 | 0x09847B6187BB5F6F6728B4ED610088FAD9DADFC00748E9D |
| | | | CD8A0CE320D6C991654ABE05 |
| 53 | 21 | 1 | 0x3285AE0A3D196313659C37BE1C94D61D20F11FD49D9FDF9 |
| | | | D1026FF5763F02CB78AE135C |
| 54 | 22 | 1 | 0x0069D3F34D0D455AFB45FEFDF716333B785C6BDA90DA23 |
| | | | F1CC68BC6A1DBC916C595DA3E |
| 55 | 23 | 1 | 0xAA977A8BCA39381E7C35A1ACC7C4F60421C0862BFD6106 |
| | | | C7C025B0676EA0EF68972DD8F |
| 56 | 24 | 1 | 0xF310745C497094ABE56E0490C0800319DBE290553E696B685 |
| | | | 9635AF03B121F79D925D19 |
| 57 | 25 | 1 | 0x964DFD350B9C7DFDC7F6F7C43283A76F0D613E48A5520D1 |
| | | | DAF761C6F47E389B43A023F5 |
| 58 | 26 | 1 | 0x6D767B88D28A455CC3B56C942BAFD8E465A50FD2C22FE6 |
| | | | 162E03A9AAC3C1CC899800610 |
| 59 | 27 | 1 | 0xC5491C6CA3D998906EC1482F815B74B7C2E3816B682ACC6 |
| | | | 009AB7EFF34BF0E9CE59C754 |
| 60 | 28 | 1 | 0x6D8EE32D30E19D93A0E5AD8226BAE9CF6FCBA17CF6E67F |
| | | | DC5A15A81ECB8908BEDD77C80 |
| 61 | 29 | 1 | 0x98F8BFDF774C7A249418E6FF4723D6E6AB2F091CDE4DE1C |
| | | | E11D3BD463B509FB716940FD |
| 62 | 30 | 1 | 0x65300BAD8FFA21BC7DC2C1F79FA97A9F469CCC9E270A61 |
| | | | 759F34D6276F57CBEB009CD21 |
| 63 | 31 | 1 | 0x6F36BB6D5A7DC4FB720439E91FF0DE86DD6C4B93CFC427 |
| | | | 1F2BCC6169616E3AEAA19E360 |
| 64 | 0 | 2 | 0xD27B00C70A8AA2C036ADD4E99D047A376B363FEDC287B8 |
| | | | FD1A7794818C5873ECD0D3D56 |
| 65 | 1 | 2 | 0xE7FDDCEED8D31B2C0752D976DE92BEA241A713CF818C27 |
| | | | 4AA1C2E3862C7EB7023AF35D4 |
| 66 | 2 | 2 | 0x87BF4954022D30549DF7348477EACB97AC3565B838460CC6 |
| | | | 2F242883313B15C31370335 |
| 67 | 3 | 2 | 0x82DD830BEDE4F13C76E4CF9AEF5E42609F0BDDCB000A74 |
| | | | 2B6372DD5225B0C3114494746 |
| 68 | 4 | 2 | 0x4E06E4CF46E1F5691938D7F40179D8F79A85216775384BD97 |
| | | | 966DB4BBF49FB6FAB8F945 |
| 69 | 5 | 2 | 0x64164534569A5E670FDB390D09C04802DD6A16B022CADC7 |
| | | | 7EDD7464AFED43C773A8DC76 |
| 70 | 6 | 2 | 0xFB8769A81AA9DB607F14A6A95948401F83057CDC9C9C399 |
| | | | 6BA5821403A49F00A4E35191 |
| 71 | 7 | 2 | 0x77710D6F40B4F79CC63F678551C3EC18FA9DF2C82E6C8F41 |
| | | | 5DADFD63264B7513180070E |
| 72 | 8 | 2 | 0x503F196BBF93C238BFD5E735E5AE52E0DAE64F5E2F4C3B9 |
| | | | 2E553F51303C4A64C4403BF3 |
| 73 | 9 | 2 | 0x5FD4A6894566678C95B9D5A59DDE5366799045FEB03A2BA |
| | | | A74094140E9068C61C2E972C |
| 74 | 10 | 2 | 0x95B584DC40C8B5DEAD63D48FCE65B1E61BAB4C597D921 |
| | | | DB12677141E2FFE7C0AA3DA0D5 |
| 75 | 11 | 2 | 0x985763AB6CC8934DB8A0BE738A7AF1D1FA3958C1F9E2D6 |
| | | | A51A163E47A0A6E5FEB759FDD |
| 76 | 12 | 2 | 0xFD8D45F00D943AD986BD353D61C6746DBF8A309B6AE1C1 |
| | | | 73B880D957B76DC031A957E8D |
| 77 | 13 | 2 | 0xAE4323534F6EFB1A20169328417885EF304FA220389FA9C26 |
| | | | 07E5A406F4CE4A7498A39F |
| 78 | 14 | 2 | 0xE5205579893BE184CB9948C28E2F9AAF699D47B6E5E0B219 |
| | | | CBEAFE4BEC8D561BD809E34 |
| 79 | 15 | 2 | 0xAB11D6941478D36D5695CE813070DC1E32122A39083E53FE |
| | | | 373660AEB125D83383FBDCA |
| 80 | 16 | 2 | 0x188A09C46F1F11206FF9F15CFB5F6CD2F26C4BF485EE37D3 |
| | | | 650A595064F76CE34E40EAD |
| 81 | 17 | 2 | 0x4B1CDE25539A56CEDC45FE7F54C38CF155F4FB1AE868F6C |
| | | | 3952D07014BF828E810BDE2D |
| 82 | 18 | 2 | 0x16CA8F8C6A879E865E3611EAC389D56AFA3E4E84CDBB73 |
| | | | 567BA4A160249C4B680A7D9BC |
| 83 | 19 | 2 | 0x39D2B08AA0E2E8781476027B41AD72F8D9838B7001AADF |
| | | | D33A92D81E56ECBB2C9378D58 |
| 84 | 20 | 2 | 0x8C258BC80D4AD125F335A5151EDF9E9A463E06C5C8D046F |
| | | | 82E5DC3D73EF4D2231C5D14F |
| 85 | 21 | 2 | 0x41A029C6356C825585179C5348EDF07A3AC2022539AC28DC |
| | | | 4CD3C1DFADC8EE9644CD939 |
| 86 | 22 | 2 | 0x0D70A77CBE9804913BFBEC4FBF917C5CD3580F6062BBAD |
| | | | 3F99ECEBB4A9EBB87523AB722 |
| 87 | 23 | 2 | 0x6A00A30901F9FDE44B4F1ECED44E0BCB943B29519F313BE |
| | | | 4496D34F39B154FC2384CB75 |
| 88 | 24 | 2 | 0x95351107A8BE6ABFC24C1292FE1A0FE677CBFD04F2E8117 |
| | | | 8CAA9D294730EF9C946F676E |
| 89 | 25 | 2 | 0x01F21470FD9B1E0B3C6B2F7C0412A15764C277D61BA2EE3 |
| | | | B3769DE7ADACB2BB29918FB7 |
| 90 | 26 | 2 | 0xA578ABFE155369440FA3D4DF757CCA596469B80A0E56BFE |
| | | | 6010DD63E67CEDB86BB1EF39 |
| 91 | 27 | 2 | 0x1E1CFFAB031836777DE5D168A9246C559574C74CCC06405E |
| | | | B406B8DDB7C9A6EF54A66A5 |
| 92 | 28 | 2 | 0x354149C2CA19A735F9CD04AF4922E8ECE6509B978B951F94 |
| | | | 6FD4AD36C7F9C83624205E7 |
| 93 | 29 | 2 | 0x5A27E60DEA547D0D41897A03199F28A967AC51728E3B3832 |
| | | | 5B4FBECF1B85A7EE9B04182 |
| 94 | 30 | 2 | 0x784DA3B16B810FE3B851060AD7BD27D9D9457F6C8899A13 |
| | | | D311E531B855C15ECE6D3A2F |
| 95 | 31 | 2 | 0xD7DFBC65797633A8C13D3EEC781D48952338136063B579D6 |
| | | | 9437B28B744B5A4BE18AFA9 |
| 96 | 0 | 0 | 0x61AF26BD39A9FFF52826625E04ADA299385A373FA946D837 |
| | | | D754E6CFEBB26F5C03B87CF |
| 97 | 1 | 1 | 0xD77D97CDB93DBEAA65CAFA146F40D72B5E80944F750E07 |
| | | | 325DC164ED60F32434BC7187D |
| 98 | 2 | 2 | 0x4529D9CA65AF49C1C39BDC18CFAB87E03FE4DAFC0A48F |
| | | | F1457D46B0DF66B414A23ACDDB |
| 99 | 3 | 0 | 0x33AC0261DAA57C1D611EBA1C730D50AFEE5BE3E849030A |
| | | | 4E891BC8C5F4C78DCDDFEA263 |
| 100 | 4 | 1 | 0xBED48C704F02A84F03BCD299D919DA56F7B71EDF8A0F8A |
| | | | 25E8F8496F95A44CE2B9F74C9 |
| 101 | 5 | 2 | 0x0ECCBE0902EBF4B4C29506014A3706622784B7B2D5153E10 |
| | | | AD3112DC5E45277A32E79DE |
| 102 | 6 | 0 | 0x7CB4937889C7DFD9AA2D37235E06F993D3D4F5D515B39C |
| | | | A652F62397C08457D66BC5A36 |
| 103 | 7 | 1 | 0x43F23F6CAC6C43896B3EDBF00E1CBD42E2CC75E2A996448 |
| | | | F0FCF17F6779DD6E356FED11 |
| 104 | 8 | 2 | 0x72C8A209FBC4A568BEF03BCFE1B0D959F977B0963780B4E |
| | | | 54E2B9A1016344ACB7EE3E3A |
| 105 | 9 | 0 | 0x77AEB9E50DC3727849A94FBFFCDB5B9589AF50ABD8A588 |
| | | | 08B9663058E17A2EBC496DF43 |
| 106 | 10 | 1 | 0x667123C89077FE4AAAEF15C635E976C6811682D478FFC7B7 |
| | | | 21A76B5A38697DF4FB7D2CE |
| 107 | 11 | 2 | 0xCBD6C5C9BE55B0BE76AD03392E8A8AB9A86063DB31B79 |
| | | | 280B447980BB841FD7E9DC6B9B |
| 108 | 12 | 0 | 0xC7D7DEF8B3C9C8667D8D65063B4DAD1FF69445C87CA71D |
| | | | A955D0CA23970E988A6EA4C83 |
| 109 | 13 | 1 | 0xFB246ABD92F9E560CB2BEC2317204C9CE22AD3BD19EA02 |
| | | | E90F5F3B7F4F65538D8ED098E |
| 110 | 14 | 2 | 0x29E74579472FDD8FFC2700B2BF33C649989DD8153093A7CA |
| | | | 08B50F7A5E4BAED108A0F0D |
| 111 | 15 | 0 | 0xA27F29D8D6CCD7EB4BBE303C3E9E95802DB98BFD5B8ED |
| | | | 03B88304359D92E3EC108CA3C8 |
| 112 | 16 | 1 | 0x3FE70E26FA00327FE3B2BE6BC5D5014F588F09C17D222C14 |
| | | | 6DD68B4824692A651888C76 |
| 113 | 17 | 2 | 0x41E91307EC58801CFF2C7E9CFEFBEB71681FAE2BEAEC72 |
| | | | D4E4556E99345D3BA4B369B59 |

TABLE 309b
Preamble modulation series per segment and IDcell for the 512 FFT mode

| Index | IDcell | Segment | Series to modulate (Wₖ) |
|---|---|---|---|
| 0 | 0 | 0 | 0x66C9CB4D1C8F31D60F5795886EE02FFF6BE4 |
| 1 | 1 | 0 | 0xD8C30DA58B5ED71056C5D79032B80E05522C |
| 2 | 2 | 0 | 0x8EB62664E3B2C5222DE18E9000561F25AAFC |
| 3 | 3 | 0 | 0x3B32299087C257CD31C67E4AA5DD697B0E08 |
| 4 | 4 | 0 | 0xC07E0B0C5DB44071EE6CEC40CA3135CB5DB8 |
| 5 | 5 | 0 | 0x89B08CD299A8AC757DB59107AF4E1EF1EE1C |
| 6 | 6 | 0 | 0x1B72E8C0ECFAABF050091382B411B45A718C |
| 7 | 7 | 0 | 0x5B33ED5A6303397EC3CCC35C8203A5A05178 |
| 8 | 8 | 0 | 0xAD1173C461254BF9181238319F93F86AF964 |
| 9 | 9 | 0 | 0x51E2005BBA69C858BCC741D84990B657271C |
| 10 | 10 | 0 | 0x21A03B607DD96F270CBC759B2A9BD6A84A34 |
| 11 | 11 | 0 | 0x4518EC4C7AD645D24AD949B42A7881403C7C |
| 12 | 12 | 0 | 0xF8B70C595A37315D301D378A4D2848C821D4 |
| 13 | 13 | 0 | 0xFF42582005F8382C5CC6298D757155B36B24 |
| 14 | 14 | 0 | 0x599EF40107CBB3B30AF945365494A0D60570 |
| 15 | 15 | 0 | 0xC6D6BE87F0D88458ABD22DE822B64E450738 |
| 16 | 16 | 0 | 0xE043896829F236B10A35014D9E4F26ECB95C |
| 17 | 17 | 0 | 0x2347472A610FC084C71460393AEF36CBE928 |
| 18 | 18 | 0 | 0x5F4D880DC516DC0B3860DA948225D2BC6770 |
| 19 | 19 | 0 | 0x9EFEEA99631FAF0D9589E9640BCD56C5FF08 |
| 20 | 20 | 0 | 0xFE792EF83B235B3D4A6447BED27035454BC0 |
| 21 | 21 | 0 | 0xB3B1B868C121C4555A64161B654A4FE81D70 |
| 22 | 22 | 0 | 0xB7C2D44078510ADD2447D93E8A1231AE3910 |
| 23 | 23 | 0 | 0x16A9D8F71CC1CD0EFA0008AA343A7A4ADA4C |
| 24 | 24 | 0 | 0x7389FDE96166E7E40F7A6778AA02944937A4 |
| 25 | 25 | 0 | 0xA0598A0907798B3465DD8CBD08565F0FB5B8 |
| 26 | 26 | 0 | 0x0E75B3C128085C954A25E5808FC5833A8FB0 |
| 27 | 27 | 0 | 0xBBCDA362265B4D4D2BEE80F635E638316280 |
| 28 | 28 | 0 | 0x660047B06A1B5FAE6A9F0679DBCA9B1A2DF4 |
| 29 | 29 | 0 | 0x2594AE119CB87E802D67EF7EE0EAE99474CC |
| 30 | 30 | 0 | 0x8FB3FA462D2CFAF842BB5319D9786A997C10 |
| 31 | 31 | 0 | 0x599E199B609C0C654DB053E8C94F343AAFF8 |
| 32 | 0 | 1 | 0xE0187D89220D11B5F60DAC078A5E2EED6EF0 |
| 33 | 1 | 1 | 0x69F57E074F14A10FEC6144C26E98C4688330 |
| 34 | 2 | 1 | 0xD2C4067132528AA41BBE61A9C171A382F768 |
| 35 | 3 | 1 | 0xB027CB82594D3900700B541A99CCD5FD5870 |
| 36 | 4 | 1 | 0xE9B565C61F73EC6633A1F2D96EC409495B80 |
| 37 | 5 | 1 | 0xEBD7E29110582C5951233AB22B03DE709698 |
| 38 | 6 | 1 | 0x0CCA91DA1B42B0B55C924F32B08B1FAE0E18 |
| 39 | 7 | 1 | 0xA4213FFB85B56E27C74FC6ECBA359875438C |
| 40 | 8 | 1 | 0x1A37F92589686CFE5E4D4BFD8E2BC63AA8CC |
| 41 | 9 | 1 | 0x31531C7B2F7518BF59ACFB216FC74D09F2F4 |
| 42 | 10 | 1 | 0xCE026112DF00BB74E1B1F43B595112B16344 |
| 43 | 11 | 1 | 0x503494DE054AE395883AEDD8CC7801B8F124 |
| 44 | 12 | 1 | 0x8447E25CA9A0EE1CFB9FADB6C42B8F565B3C |
| 45 | 13 | 1 | 0x757C45DA8F140FB6E71024294B2439CDACFC |
| 46 | 14 | 1 | 0xF2A59A32B51CE505E45E9B5C7C7DBE880DF4 |
| 47 | 15 | 1 | 0x8DFBF09479BC91E466A539E077D2B26A8B2C |
| 48 | 16 | 1 | 0x1C6FB87D76DB82FFA1E492166684CACEE560 |
| 49 | 17 | 1 | 0xA32CF584137FDF1D4CCE6A1CF40FEC1F4AE0 |
| 50 | 18 | 1 | 0xEC4D3AC52136FA468F28777078C8A82C0808 |
| 51 | 19 | 1 | 0x30CABB208C9D6C774814A163765E4ACBC540 |
| 52 | 20 | 1 | 0xCA3448C6716F6F8D15D7372A3A4F6E825A14 |
| 53 | 21 | 1 | 0xABD1526F4A510F820B689F30C1E7B88C8848 |
| 54 | 22 | 1 | 0x94E4E2AE2C4E47FD7D0A154C25BF40F759E0 |
| 55 | 23 | 1 | 0x43BFFD566D85BE162650670BE1A3CA523284 |
| 56 | 24 | 1 | 0xD7644475A2E5EDAD1AD184242E3C841A03E0 |
| 57 | 25 | 1 | 0xA61DDBA416D1D14358647C4ACEF2503001E4 |
| 58 | 26 | 1 | 0x1F9047A8651D4D4A7C582469DC8C41B68E08 |
| 59 | 27 | 1 | 0xE0EAC02D975263F36D4BEF70669CBDEE658C |
| 60 | 28 | 1 | 0xDFAE7334BD2B8FF1D2C7CB5922823B03F744 |
| 61 | 29 | 1 | 0xD44B2AD5842F1EEA1A39DBC64EC064FCCFBC |
| 62 | 30 | 1 | 0x08AD296C8D17ABD021E02E20DACC247673EC |
| 63 | 31 | 1 | 0x2FE66830D806B3F8DD38D5FE1CF12DEB9774 |
| 64 | 0 | 2 | 0xC6325F42597BD48A8914944C7DB973D83E64 |
| 65 | 1 | 2 | 0xE04B98E9254434D3F765A621752C0F1FEC54 |
| 66 | 2 | 2 | 0xA74B60D84CCB156B1B8AE015B8CE980868EC |
| 67 | 3 | 2 | 0x78E7405DCFDA1DFCDA6E54B3794B49A0F8B0 |
| 68 | 4 | 2 | 0xF32F4CA1A154E746FE1C2D1E4A1251779804 |
| 69 | 5 | 2 | 0x5A2905A1CF5D06444C880ADC07EB3889E71C |
| 70 | 6 | 2 | 0x74290661C664DEB829569B7C4E6C32B2BE00 |
| 71 | 7 | 2 | 0xEBB53241F5D9CD87A612C0774ED2FED4679C |
| 72 | 8 | 2 | 0xE33B89ABA4ED020D558B833AF74072922164 |
| 73 | 9 | 2 | 0x3B7D2DEEF829E230718AA7996CD814A4DD88 |
| 74 | 10 | 2 | 0x373861E8993FC22E176F6DA6A46A10158EF4 |
| 75 | 11 | 2 | 0x2BEA329B65DE1CD26ECDD382915AC40B1D0C |
| 76 | 12 | 2 | 0x7A8B131BD5D1270C30003DA472DD81D9A434 |
| 77 | 13 | 2 | 0x9D6A237940057479D30BE19AD719F8F9B47C |
| 78 | 14 | 2 | 0xC1FB9C3811B349E9F793A14C8AE8425A6218 |
| 79 | 15 | 2 | 0xDFFDE03D8C717A346B4B1D3C02693330A9B4 |
| 80 | 16 | 2 | 0x76254DEF89683CD7210898069E2CDA0EE144 |
| 81 | 17 | 2 | 0x09B9B69C132C4E2DC16A1438828147D65F94 |
| 82 | 18 | 2 | 0xB1CCE0D47DF246E9059CBC970168518206AC |
| 83 | 19 | 2 | 0x1017669D7990F3AB4378924C69E442F2BAD0 |
| 84 | 20 | 2 | 0x772407B19C5FA41D542C8A2DC9ADD2C2943C |
| 85 | 21 | 2 | 0x7A38C2889EB10D93F23EC75B212D327D18A8 |
| 86 | 22 | 2 | 0xD25A195D899BF6F531F5ECC228BE0678A438 |
| 87 | 23 | 2 | 0xA83FD1C33F4C6CAA5A0E8B062937AC310034 |
| 88 | 24 | 2 | 0xAA6DDD1A05ADF49F615BE9F9EBCA6630E440 |
| 89 | 25 | 2 | 0xB14990574937763EEBD71A12FEB0C673F878 |
| 90 | 26 | 2 | 0xDDF013D74BDDE5FBB621A32B54DE24AA1D60 |
| 91 | 27 | 2 | 0xD814295D387D2EE33F90C07CA493062B3054 |
| 92 | 28 | 2 | 0x89B93046231A786C3D74ABAEC6AFF42D037C |
| 93 | 29 | 2 | 0x5680E918BA19199E841B4D6A7D1DD1420E78 |
| 94 | 30 | 2 | 0x639CC821373B332F975817C0A1AC16A48150 |
| 95 | 31 | 2 | 0x06711D78BD8978D82DA58B7E494DDF77E994 |
| 96 | 0 | 0 | 0xC882DD8DBD23C796A1389DA4EAA9A4138640 |
| 97 | 1 | 1 | 0x038086D70895496BCABC404B1EC999F67AC0 |
| 98 | 2 | 2 | 0x8203073A335DB9E57B0CA2F07D5958176B50 |
| 99 | 3 | 0 | 0x3FF1CD3638EE6469A4A482AF834EF56A2340 |
| 100 | 4 | 1 | 0x69EA7871159D5099F900C6133C07DABF56F0 |
| 101 | 5 | 2 | 0x4D88ABB17FF855393EDBC070CF0439D5E94C |
| 102 | 6 | 0 | 0x01EFD43C87362B00E376A728BC597BEED978 |
| 103 | 7 | 1 | 0x7AE20D16F3CC6F947413518FDF6E1FCCCDE8 |
| 104 | 8 | 2 | 0xBB852F9A90B0DE260BB67F45491B31DE3A74 |
| 105 | 9 | 0 | 0x088627544BDF971C1AC4F86F05A212EE9634 |
| 106 | 10 | 1 | 0x0C8A08A37C2B9D3C1812E9C116B4E6A6285C |
| 107 | 11 | 2 | 0xE74775CADDDDF0D2D808FE7FC1C177489284 |
| 108 | 12 | 0 | 0xE81ECC6AC393294E9B549A8B2BADE7FFF904 |
| 109 | 13 | 1 | 0x1C5FAE8CACE7A2CD13CAF4A34A440E909BF8 |
| 110 | 14 | 2 | 0x6EE7E42A292BDACC5C79B81CA6598274C940 |
| 111 | 15 | 0 | 0x407547BC0C961D9E9ADDE010F4990724E8DC |
| 112 | 16 | 1 | 0x46CE626ACD894F9650E6B7C3F9E3BFAE5B08 |
| 113 | 17 | 2 | 0xC59B894FBF170F44F4816750280AB8CB4E48 |

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
wirelessly transmitting, by a base station in a multi-hop network, a preamble series to be received by a subscriber station in the network,
wirelessly transmitting, by the base station, a reverse version of the preamble series to be received by a relay station in the network,
receiving, by the relay station, the transmitted reverse version of the preamble series, and
receiving, by the subscriber station, the transmitted the preamble series.

2. The method according to claim 1, wherein said wirelessly transmitting the preamble series transmits the preamble series at the head of a downlink transmission.

3. The method according to claim 1, wherein said wirelessly transmitting the reverse version of the preamble series transmits the reverse version of the preamble series using a relay zone.

4. The method according to claim 1, wherein said wirelessly transmitting the preamble series and said wirelessly transmitting the reverse version of the preamble series transmit the preamble series and the reverse version of the preamble series within one wireless frame.

5. The method according to claim 4, further comprising:
detecting, by the subscriber station, only the preamble series among the preamble series and the reverse version of the preamble series transmitted within the one wireless frame.

6. The method according to claim 1, wherein the subscriber station does not perform a detection process of the reverse version of the preamble series.

7. The method according to claim 1, further comprising:
using the transmitted preamble series and the transmitted reverse version of the preamble series for time synchronization, carrier frequency estimation, channel response estimation, or cell and sector identification.

8. A system comprising:
a base station in a multi-hop network, the base station wirelessly transmitting a preamble series and a reverse version of the preamble series,
a relay station in the network, the relay station receiving the transmitted reverse version of the preamble series, and
a subscriber station in the network, the subscriber station receiving the transmitted preamble series.

9. A base station for use in a multi-hop network, wherein
the base station transmits a preamble series to a subscriber station in the network and transmits a reverse version of the preamble series to a relay station in the network.

10. A relay station for use in a multi-hop network having a base station, the relay station, and a subscriber station, wherein
the relay station receives a reverse version of a preamble series transmitted from the base station, and
the preamble series is transmitted from the base station to the subscriber station.

11. A subscriber station for use in a multi-hop network having a base station, a relay station, and the subscriber station, wherein
the subscriber station receives a preamble series transmitted from the base station, and
a reverse version of the preamble series is transmitted from the base station to the relay station.
